(19) United States
(12) Patent Application Publication
(10) Pub. No.: US 2026/0195189 A1
(43) Pub. Date: Jul. 9, 2026

(54) Resource Extraction and Processing System

(71) Applicant: Vanilla Technologies Inc., Bellevue, WA (US)

(72) Inventors: Amjad Hussain, Newcastle, WA (US); Kei Daniel Yasui, Los Angeles, CA (US); Alexander Pines, Los Angeles, CA (US); Samuel Winthrop Trapkin, Post Falls, ID (US); Steven D. Lockshin, Beaverton, OR (US); Eugene Michael Farrell, Sammamish, WA (US)

(21) Appl. No.: 19/013,874

(22) Filed: Jan. 8, 2025

(51) Int. Cl. G06F 9/50; G06F 40/205

(52) U.S. Cl. CPC G06F 9/5061; G06F 9/5027; G06F 40/205

(57) ABSTRACT

Provided are methods, systems, devices, apparatuses, and tangible non-transitory computer readable media for resource extraction and processing. Resource document data comprising resource documents associated with resource allocation instructions for distribution of resources to entities can be received. Resource document fields and resource document field values of the resource documents can be determined. Based on inputting the document data into a machine-learning model, resource data associated with the resource documents can be generated. The machine-learning model can be configured to parse the resource documents and determine relationships associated with the entities, the resources, or provisions of the resource documents. Based on the resource data, key provisions of the provisions of the resource documents can be determined. Furthermore, a resource profile based on the resource data can be generated. The resource profile can comprise indications associated with the key provisions of the resource documents.

### FIELD

The present disclosure relates generally to systems for extracting and processing resources. More particularly, the present disclosure relates to computing systems that are configured to generate resource data and implement machine-learning models that can process the resource data.

### BACKGROUND

Resource extraction and processing can be a complex process that involves various different entities that extract and process the resources. As a result of the large number of documents that can be involved in resource extraction and processing, as well as the many rules and policies related to the underlying resources, a significant amount of time and effort can be expended in ensuring that the resources are properly extracted and processed. Further, in response to changes in the rules or the composition of recipients of the resources, instructions to disburse resources can undergo numerous revisions that, in addition to being expensive, can significantly change the resource disbursal process. To address the many challenges associated with resource extraction and processing, different types of software can be used to collect, store, and disseminate the resource information to others. However, the use of multiple software applications to manage resources can be burdensome and demand a significant amount of manual input. Additionally, generalized software applications may not be fully suited to meeting the often specialized requirements of resource extraction and processing. As such, there are many different approaches that can be used in resource extraction and processing.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method that can comprise receiving, by a computing system comprising one or more processors, resource document data comprising one or more resource documents associated with resource allocation instructions for distribution of one or more resources to one or more entities. The computer-implemented method can comprise determining, by the computing system, based on performance of one or more detection operations on the resource document data, one or more resource document fields and one or more resource document field values of the one or more resource documents. The computer-implemented method can comprise generating, by the computing system, based on inputting the resource document data into one or more machine-learning models, resource data associated with the one or more resource documents. The resource data can comprise one or more resource data fields and one or more resource data field values. The one or more resource data fields can be based on the one or more resource document fields. The one or more resource data field values can be based on the one or more resource document field values. The one or more machine-learning models can be configured to parse the one or more resource documents and determine one or more relationships associated with the one or more entities, the one or more resources, or one or more provisions of the one or more resource documents. The computer-implemented method can comprise determining, by the computing system, based on the resource data, one or more key provisions of the one or more provisions of the one or more resource documents. Furthermore, the computer-implemented method can comprise generating, by the computing system, a resource profile based on the resource data. The resource profile can comprise one or more indications associated with the one or more key provisions of the one or more resource documents.

Another example aspect of the present disclosure is directed to a computing system including: one or more processors; and one or more non-transitory computer-readable media storing instructions that when executed by the one or more processors cause the one or more processors to perform operations. The operations can comprise receiving resource document data comprising one or more resource documents associated with resource allocation instructions for distribution of one or more resources to one or more entities. The operations can comprise determining, based on performance of one or more detection operations on the resource document data, one or more resource document fields and one or more resource document field values of the one or more resource documents. The operations can comprise generating, based on inputting the resource document data into one or more machine-learning models, resource data associated with the one or more resource documents. The resource data can comprise one or more resource data fields and one or more resource data field values. The one or more resource data fields can be based on the one or more resource document fields. The one or more resource data field values can be based on the one or more resource document field values. The one or more machine-learning models can be configured to parse the one or more resource documents and determine one or more relationships associated with the one or more entities, the one or more resources, or one or more provisions of the one or more resource documents. The operations can comprise determining, based on the resource data, one or more key provisions of the one or more provisions of the one or more resource documents. Furthermore, the operations can comprise generating a resource profile based on the resource data. The resource profile can comprise one or more indications associated with the one or more key provisions of the one or more resource documents.

Another example aspect of the present disclosure is directed to one or more tangible non-transitory computer-readable media that collectively store instructions that when executed by one or more processors cause the one or more processors to perform operations. The operations can comprise receiving resource document data comprising one or more resource documents associated with resource allocation instructions for distribution of one or more resources to one or more entities. The operations can comprise determining, based on performance of one or more detection operations on the resource document data, one or more resource document fields and one or more resource document field values of the one or more resource documents. The operations can comprise generating, based on inputting the resource document data into one or more machine-learning models, resource data associated with the one or more resource documents. The resource data can comprise one or more resource data fields and one or more resource data field values. The one or more resource data fields can be based on the one or more resource document fields. The one or more resource data field values can be based on the one or more resource document field values. The one or more machine-learning models can be configured to parse the one or more resource documents and determine one or more relationships associated with the one or more entities, the one or more resources, or one or more provisions of the one or more resource documents. The operations can comprise determining, based on the resource data, one or more key provisions of the one or more provisions of the one or more resource documents. Furthermore, the operations can comprise generating a resource profile based on the resource data. The resource profile can comprise one or more indications associated with the one or more key provisions of the one or more resource documents.

Other aspects of the present disclosure are directed to various systems, apparatuses, non-transitory computer-readable media, user interfaces, and devices for resource extraction and processing. These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example environment including a computing system that performs operations, according to example embodiments of the present disclosure;

FIG. 2 depicts a block diagram of an example of a computing device, according to example embodiments of the present disclosure;

FIG. 3 depicts a diagram of an example machine-learning model according to example embodiments of the present disclosure;

FIG. 4 depicts an example of an interface for resource document data and resource data according to example embodiments of the present disclosure;

FIG. 5 depicts an example of an interface for resource document data and resource data according to example embodiments of the present disclosure;

FIG. 6 depicts an example of an interface for resource document data and resource data according to example embodiments of the present disclosure;

FIG. 7 depicts a flow diagram of an example method for extracting and processing resource data according to example embodiments of the present disclosure;

FIG. 8 depicts a flow diagram of an example method for extracting and processing resource data according to example embodiments of the present disclosure;

FIG. 9 depicts a flow diagram of an example method for extracting and processing resource data according to example embodiments of the present disclosure;

FIG. 10 depicts a flow diagram of an example method for extracting and processing resource data according to example embodiments of the present disclosure; and

FIG. 11 depicts a flow diagram of an example method for extracting and processing resource data according to example embodiments of the present disclosure.

Reference numerals that are repeated across plural figures are intended to identify the same features in various implementations.

### DETAILED DESCRIPTION

In general, the present disclosure is directed to generating and processing data including resource data associated with the allocation and processing of resources. In accordance with this disclosure, a customized analysis of resource documents including data relating to the resources and entities associated with the resource documents can be extracted and used to automatically perform various operations associated with resource allocation and processing. In some embodiments, the disclosed technology can receive information from various sources and generate a resource profile that includes indications associated with key provisions of the resources and/or resource documents. The disclosed technology can also implement machine-learning models that have been configured and/or trained to receive resource document data and generate resource data based on resource documents included in the resource document data. The use of machine-learning models can significantly increase the speed of resource data generation by automatically processing resource documents and generating highly accurate resource data.

Additionally, the present disclosure is directed to improved computer systems, computer applications, computer-implemented methods, user interfaces, and/or services for resource extraction, allocation, and/or processing. In some instances, the resource allocation systems and methods described herein can be used to structure and visualize an existing resource profile, strategize potential opportunities, offer online document creation, and create a collaborative online space for accessing current resources profiles and documents.

As used herein, the terms “resource” and/or “asset” can each refer to the corresponding term itself individually, or one or more terms from the list of terms collectively. Further, the term “document” may include paper documents (e.g., hardcopies), electronic documents, and/or computer based documents (e.g., files stored on a storage device of a computing system). Further, as used herein, the term “resource” may include tangible resources (e.g., physically tangible resources which can include vehicles, houses, and/or computing devices) and/or intangible resources (e.g., access rights and/or intellectual property rights).

In some instances, the disclosed technology can provide greater visibility into a user's resource profile and provision of resource documents. This can provide resource advisors with the real-time status of resource documents, reports, and/or tasks. In some instances, a resource data generation flow in which resource documents are automatically processed using machine-learning models can result in more accurate resource data and the identification of key provisions of the resource documents. Furthermore, the disclosed technology can be easy to use, integrated with other financial technology systems, and secure.

For example, a computing system can receive resource document data that can comprise one or more resource documents that are associated with resource allocation instructions for distribution of one or more resources to one or more entities. For example, the one or more resource documents can comprise a network policy, authentication policy, legal documents, estate documents, a will, deeds to property, beneficiary designations, a power of attorney, insurance policy, healthcare directives, and/or other types of documents that are associated with resources. Further, the resource document data can indicate how the resources indicated in the resource documents can be allocated to various entities. For example, the resource documents can comprise a computing device policy that indicates how computing devices can be allocated to users or a will that indicates how assets of an estate can be allocated to beneficiaries of the estate.

The computing system can determine, based on performance of detection operations on the resource document data, one or more resource document fields and/or one or more resource document field values of the one or more resource documents. For example, the computing device can determine document fields that identify one or more resources (e.g., network resources or resources of an estate) and the corresponding document field values associated with the document fields (e.g., the purchase date of network equipment or the value of assets of an estate).

The computing system can generate, based on inputting the resource document data into one or more machine-learning models, resource data associated with the one or more resource documents. The one or more machine-learning models can be configured and/or trained to parse the one or more resource documents and determine one or more relationships associated with the one or more entities, the one or more resources, and/or one or more provisions of the one or more resource documents. For example, the computing system can generate resource data associated with an estate plan based on resource document data associated with the estate plan. The resource data can comprise information associated with the relationships between assets, beneficiaries, and/or provisions of the will associated with the estate. By way of further example, the computing system can generate resource data associated with a device allocation plan based on resource document data associated with a device allocation plan. The resource data can comprise information associated with the relationships between devices, users, and/or device usage policies. Based on the resource data, the computing system can determine one or more provisions of the one or more resource documents. For example, based on resource data associated with a will, key provisions of the will can be determined. By way of further example, based on resource data associated with a network policy, key provisions of the network policy can be determined.

The computing system can generate a resource profile based on the resource data and comprising indications associated with the one or more key provisions of the resource data. For example, based on resource data associated with resources of an estate, the computing system can generate a resource profile that comprises indications associated with the key provisions of the estate including key assets and/or beneficiaries. By way of further example, based on resource data associated with resources associated with a network policy, the computing system can generate a resource profile that comprises indications associated with the key provisions of the network policy including key users and network devices.

Accordingly, the disclosed technology can generate resource data based on resource documents and indications associated with key provisions of the resource documents. Further, the disclosed technology can assist a user in more effectively performing the technical task of resource data processing by means of a continued and/or guided human-machine interaction process in which resource documents are received and the disclosed technology generates real-time indications of key provisions of the resource documents based on continuously updated resource data. The disclosed technology can allow for the generation of personalized resource data and more effective identification of key provisions of resource documents.

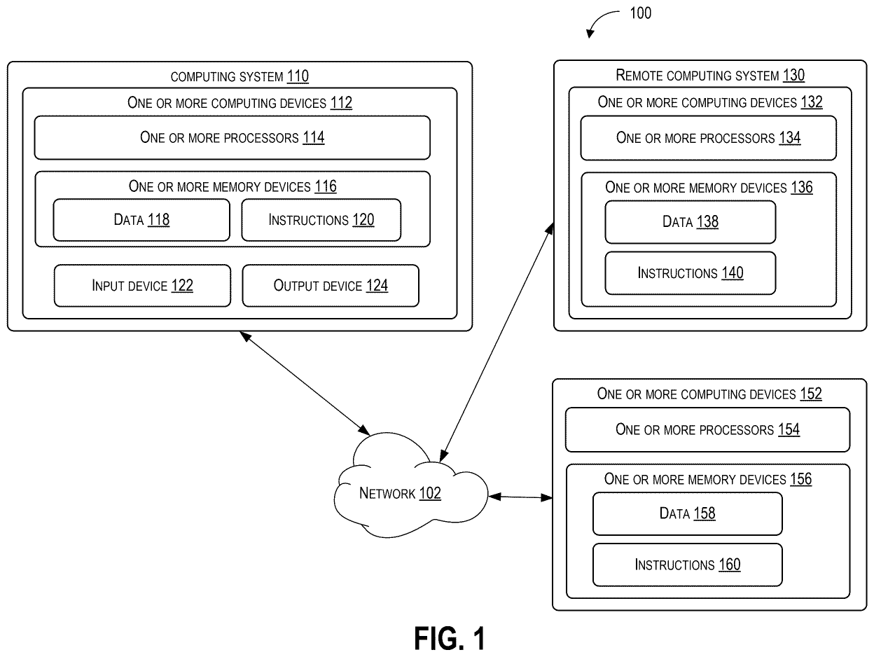

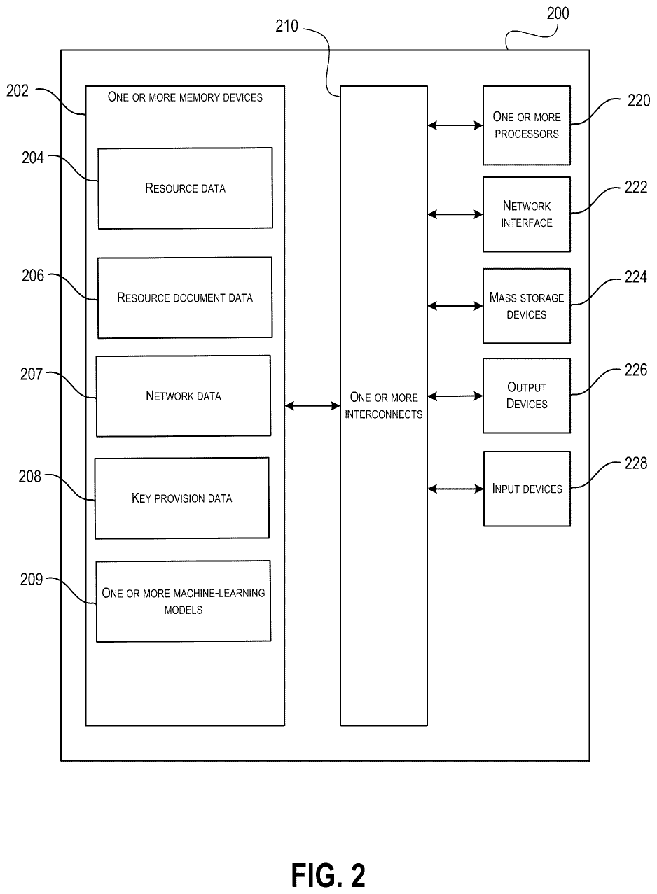

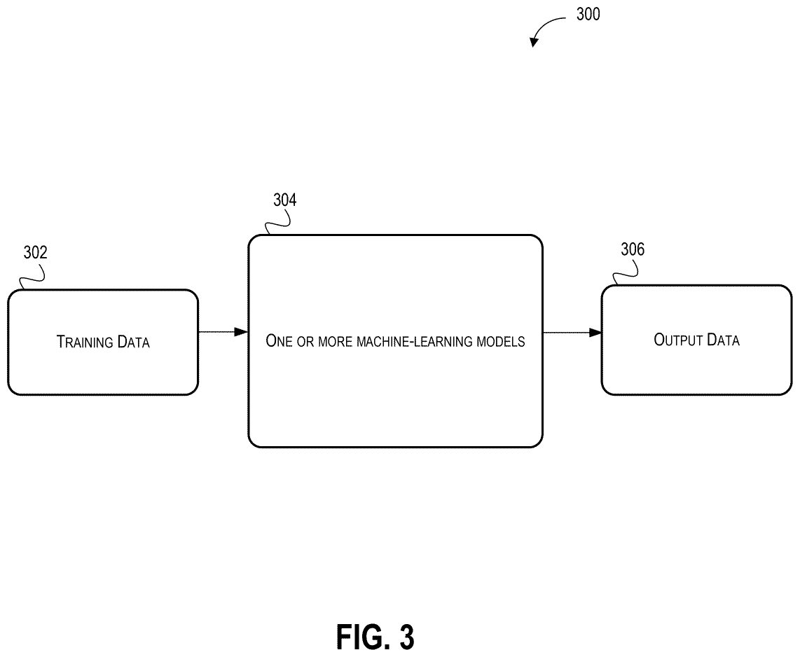

In some embodiments, the disclosed technology can comprise a computing system (e.g., a resource document processing computing system) that can comprise one or more computing devices (e.g., devices with one or more computer processors and a memory that can store one or more instructions) that can process, send, receive, generate, and/or modify data (e.g., data associated with processing resource data and/or determining key provisions of resource data). The computing system can communicate (e.g., send and/or receive data) with various other systems and/or devices (e.g., one or more remote computing systems) that can send and/or receive data including data associated with resources. In some embodiments, the computing system can comprise one or more features of the computing system 110 that is described with respect to FIG. 1 and/or the computing device 200 that is described with respect to FIG. 2. Further, the computing system can comprise and/or be associated with one or more machine-learning models that include one or more features of the one or more machine-learning models 304 that are described with respect to FIG. 3.

A computing system can receive, obtain, and/or retrieve resource document data. For example, the computing system can receive resource document data from a remote computing system that stores the resource document data. By way of further example, the computing system can access resource document data that is locally stored on the computing system. The resource document data can comprise one or more resource documents. The one or more resource documents can be associated with resource allocation instructions for distribution of one or more resources to one or more entities. In some embodiments, the computing system can access one or more databases that include information associated with the one or more resource documents. The one or more databases can comprise locally stored and/or online accessible (e.g., accessible via the Internet) databases.

The resource allocation instructions can be associated with the regulation of computing systems and/or one or more resources associated with computing systems. For example, the resource allocation instructions can be associated with one or more access policies, one or more authorization policies, one or more authentication policies, one or more computing device permissions, one or more file access permissions, and/or assignment of one or more resources (e.g., computing devices) to one or more entities (e.g., computing device users). Further, the resource allocation instructions can be associated with one or more laws (e.g., one or more federal laws and/or one or more state laws) that can be associated with various aspects of the resources including probate law, resources law, tax law, inheritance law, and/or property law. Further, the resource allocation instructions can be based on one or more provisions of the one or more resource documents (e.g., network policy documents, estate documents, an estate plan, provisions of a will, trust, healthcare directive, power of attorney, and/or insurance policy).

Further, the one or more resource documents can include one or more provisions, one or more clauses (e.g., one or more clauses comprising one or more provisions), one or more directives, one or more rules, and/or one or more references to rules that can be used to determine the ownership and/or distribution of the one or more resources. The one or more resource documents can indicate ownership of one or more resources, one or more locations of one or more resources, the monetary value of the one or more resources (e.g., an estimated or appraised value of an asset). Further, the one or more resources can be associated with one or more entities (e.g., resource recipients comprising users of computing devices and/or beneficiaries of an estate) associated with one or more resources. Further, the one or more resources can be associated with one or more computing devices (e.g., one or more computing devices that use network resources, processing resources, and/or storage resources), one or more trustees (e.g., one or more trustees of an estate), and/or one or more beneficiaries (e.g., one or more beneficiaries indicated in a will).

The one or more resource documents can comprise information associated with a time, location, and/or amount of one or more resources that can be distributed to one or more entities. Further, the one or more resource documents can comprise one or more network policies, one or more user guides, one or more access policies, one or more authorization policies, one or more authentication policies, one or more estate documents, one or more wills, one or more trusts, a power of attorney, one or more titles, one or more deeds, one or more account beneficiary designations, one or more guardianship designations, one or more insurance policies, and/or one or more healthcare directives.

In some embodiments, the one or more resources can be associated with one or more assets (e.g., cash, stocks, bonds, mutual funds, derivatives, and/or tangible property), and/or one or more property rights. Further, the one or more resources can comprise one or more computing devices (e.g., one or more laptop computing devices, smartphones, and/or desktop computing devices), one or more software resources (e.g., one or more software applications and/or access to one or more software applications), real property, tangible personal property (e.g., vehicles, books, artwork, furniture, jewelry, clothing, personal electronics, and/or sporting equipment), one or more securities, intangible property (e.g., intellectual property including patents, copyrights, and/or trademarks), and/or cash.

The computing system can determine one or more resource document fields and/or one or more resource document field values of the one or more resource documents. Determining the one or more resource document fields and/or the one or more resource document field values can be based on performance of one or more detection operations on the resource document data. For example, the computing system can perform one or more character recognition operations to recognize text in the one or more resource documents. Further, the computing system can classify one or more portions of text in the one or more resource documents as resource document fields and/or resource document field values. For example, the computing system can determine one or more portions of the one or more resource documents that correspond to one or more provisions of a will, one or more clauses of a network policy, and/or one or more instructions to allocate computing devices. The one or more resource documents can comprise one or more resource document fields. The one or more resource document fields can comprise one or more name fields associated with the one or more entities, one or more date fields associated with one or more dates, one or more resource type fields associated with one or more types of the one or more resources, and/or one or more resource value fields associated with one or more resource values of the one or more resources.

Further, the resource document fields can be associated with one or more entities and/or one or more resources. For example, the one or more resource document fields can comprise a document field associated with the make and model number of a computing device and/or a document field associated with the address of an administrator of an estate, a network address (e.g., IP address), and/or the name of tangible personal property comprising a piece of artwork (e.g., a painting or sculpture). In some embodiments, the one or more resource document fields can comprise one or more estate document fields associated with an estate and/or an estate plan (e.g., resource allocation instructions to distribute assets of an estate). Further, the one or more estate document fields can be associated with one or more estate document values that may correspond to the one or more estate document fields.

Further, the resource allocation instructions can be associated with the distribution of one or more resources of the resources to one or more entities. The resource allocation instructions can indicate the one or more entities that are associated with receiving (e.g., resource recipients) the one or more resources and/or managing (e.g., a network administrator, an executor, and/or resource manager) the one or more resources. The one or more entities can comprise one or more resource recipients, one or more network administrators, one or more users (e.g., computer users), one or more beneficiaries, one or more managers, one or more trustees of the resources (e.g., trustees of an estate), one or more employees, one or more testators associated with an estate, one or more debtors, and/or one or more creditors.

Determining the one or more resource document fields and/or the one or more resource document field values can be based on the use of one or more machine-learning models. Determining the one or more resource document fields and/or the one or more resource document field values can comprise detecting and/or recognizing, based on inputting the resource document data and/or the one or more resource documents into the one or more machine-learning models. The one or more machine-learning models can be configured to generate the one or more resource document fields and/or the one or more resource document field values based on input comprising the resource document data and/or the one or more resource documents. The one or more machine-learning models can be configured to detect, recognize, and/or parse one or more text segments in the one or more resource documents. For example, the one or more machine-learning models can be configured and/or trained to recognize resource document fields and/or resource document field values associated with resources and/or entities of an estate (e.g., names of beneficiaries, assets, asset values, and/or provisions of documents associated with an estate).

The computing system can generate resource data. The resource data can be associated with the one or more resource documents. Generating the resource data can be based on inputting the resource document data and/or the one or more resource documents into one or more machine-learning models that are configured and/or trained to generate the resource data based on input comprising the resource document data. For example, the computing system can receive resource document data associated with building plans and implement one or more machine-learning models. Based on inputting the resource data into the one or more machine-learning models, the computing system can generate resource data that is based on the resource document data, classifies one or more portions of the resource document data, and determines one or more relationships between resources comprising building materials and entities comprising building contractors, one or more relationships between entities comprising bidding building contractors, and/or one or more relationships between provisions associated with instructions to allocate materials to building sites.

The one or more machine-learning models can be configured and/or to parse the one or more resource documents and determine one or more relationships associated with the one or more entities, the one or more resources, and/or one or more provisions of the one or more resource documents. For example, the computing system can receive resource document data associated with an estate plan and implement one or more machine-learning models. Based on inputting the resource data into the one or more machine-learning models, the computing system can generate resource data that is based on the resource document data, classifies one or more portions of the resource document data, and determines one or more relationships between resources comprising assets of the estate and entities comprising estate beneficiaries, one or more relationships between entities comprising beneficiaries, and/or one or more relationships between provisions associated with instructions to allocate assets to beneficiaries.

Further, the one or more machine-learning models can be configured and/or trained to generate the resource data based on parsing the one or more resource documents, detecting one or more features of the one or more resource documents, recognizing one or more features of the one or more resource documents, and/or classifying one or more features of the one or more resource documents. For example, the one or more machine-learning models can recognize portions of the one or more resource documents that are associated with one or more entities, one or more resources, and/or one or more instructions and/or one or more directives (e.g., computing device policies, network policies, clauses of a will, insurance policy provisions, laws, and/or bank account policies) associated with distributing the one or more resources to the one or more entities. The one or more relationships can comprise one or more fiduciary relationships between the one or more entities, one or more property rights of the one or more entities over the one or more resources, one or more relationships between terms or conditions of the one or more provisions, one or more relationships between the one or more provisions and the one or more entities, and/or one or more relationships between the one or more provisions and the one or more resources.

In some embodiments, the one or more machine-learning models can comprise one or more large language models (LLMs). Further, the one or more machine-learning models can be configured and/or trained based on training data comprising one or more resource distribution agreements, one or more network policies, one or more device policies, one or more contracts, one or more wills, and/or one or more insurance policies.

The resource data can comprise one or more resource data fields and/or one or more resource data field values. For example, a resource date field can be associated with an asset (e.g., a mutual fund) and the resource data field value can be associated with the current value of the mutual fund (e.g., two million dollars). The one or more resource data field values can be based on the one or more resource data fields. For example, the resource data field value that indicates the current value of a mutual fund can correspond to the resource data field associated with the mutual fund. The one or more resource data fields can be based on the one or more resource document fields. For example, the resource document field associated with the name of a resource indicated in a resource document can correspond to the name of the resource indicated in the resource data field of the resource data. In some embodiments, the resource data and/or the resource document data can comprise estate data that can be associated the one or more resources and/or the one or more entities. Further, the resource data and/or the resource document data can comprise estate data that can be associated with an estate plan (e.g., an estate plan comprising resource allocation instructions and/or one or more provisions associated with an estate) associated with distribution of one or more resources of an estate (e.g., an estate comprising one or more resources that were previously the property of a testator) to one or more entities (e.g., one or more beneficiaries of the estate).

Generating the resource data can comprise generating an interface (e.g., a graphical user interface) that can comprise a resource document region and/or a resource data region. For example, the computing system can generate an interface that comprises a resource document region on one side of the interface (e.g., a left side of the interface) that displays a resource document. Further, the interface can display a resource data region that displays resource data on the other side of the interface (e.g., the right side of the interface). The interface can be configured to be generated on a display component associated with the computing system and can comprise one or more interface elements (e.g., windows, controls, drop-down menus, icons, and/or tabs) that can be configured to receive input via one or more input devices (e.g., a touchscreen, a mouse, a keyboard, microphone, stylus, and/or a numeric input pad).

The resource document region can be configured to display at least one resource document of the one or more resource documents. For example, the resource document region can display a portion of a will, network policy, and/or computing device distribution list. Further, the resource document region can display one or more portions of the resource document that can be selectively displayed based on one or more inputs (e.g., scrolling through a resource document via a scrollbar of the interface).

Further, generating resource data can comprise generating one or more prompts to request authorization to generate the resource data associated with the at least one resource document displayed in the resource document region. For example, the computing system can generate one or more prompts indicating “TAP HERE TO GENERATE RESOURCE DATA BASED ON THE RESOURCE DOCUMENT DISPLAYED IN THE RESOURCE DOCUMENT REGION ON THE LEFT SIDE OF THE INTERFACE.”

Further, generating the resource data can comprise generating, based on a response comprising authorization to generate the resource data, the resource data associated with the at least one resource document displayed in the resource document region. The resource data region can be configured to display a portion of the resource data associated with the at least one resource document. For example, the resource data region can display a summary of a will, network policy, or computing device distribution list. Further, as part of generating the resource data the computing system can classify resource document data comprising one or more resource document fields and/or resource document field values associated with the resource document data displayed in the resource document region. The classified resource document data can be indicated in the resource data displayed in the resource data region. For example, the resources (e.g., assets) of an estate indicated in a will can be classified and displayed in corresponding classes in the resource data region. The resource data can then be displayed in the resource data region.

Further, generating the resource data can comprise generating within the resource document region, one or more indications to emphasize the one or more resource document fields and the one or more resource document field values that are associated with the at least one resource document. For example, the computing system can generate one or more indications comprising highlighting (e.g., highlighting text of a resource document in the resource document region), underlining (e.g., underlining text of a resource document in the resource document region), and/or modifying the font of text in a resource document to be bold.

The computing system can determine based on the resource data, one or more key provisions of the one or more provisions of the one or more resource documents. The computing system can perform one or more parsing and/or one or more text processing operations to determine a semantic structure of resource data. Further, the computing system can determine one or more sections of resource data associated with a resource document (e.g., one or more sections of a network policy or an estate planning document), one or more clauses of resource data associated with a resource document (e.g., one or more clauses of a device allocation plan or a will), one or more provisions of resource data associated with a resource document (e.g., one or more provisions of a will or a network policy), and/or one or more directives of resource data associated with a resource document (e.g., one or more directives associated with a network policy or will).

For example, based on processing the resource data, the computing system can determine one or more provisions of the resource document that satisfy one or more significance criteria that indicate that the one or more provisions are key provisions. The computing system can be configured to determine the one or more key provisions based on the one or more provisions that are associated with resource data field values that exceed a threshold value. For example, the one or more key provisions can comprise the one or more provisions that comprise a resource data field value exceeding fifty thousand dollars (e.g., a work of art valued at $80,000.00). The computing system can be configured to determine the one or more key provisions based on the one or more provisions that are associated with one or more classes of resource data fields. For example, the one or more key provisions can comprise the one or more provisions that are classified as being associated with the transfer of property (e.g., transfer of computing devices to a user or assets of an estate to a beneficiary), significant dates (e.g., deadlines to return equipment or deadlines to claim assets of an estate), relinquishing rights to resources (e.g., relinquishing rights to assets of an estate), and/or obtaining rights to resources.

Determining the one or more key provisions can comprise determining, based on inputting the resource data into the one or more machine-learning models, the one or more key provisions. The one or more machine-learning models can be configured and/or trained to determine the one or more key provisions based on performance of one or more semantic reasoning operations on the one or more provisions. The one or more machine-learning models can be configured and/or trained based on training data comprising training resource data based on a plurality of training resource documents and a plurality of ground-truth key provisions. Based on inputting the plurality of training resource documents into the one or more machine-learning models, a plurality of predicted key provisions can be generated by the one or more machine-learning models. The plurality of predicted key provisions can be compared to a corresponding plurality of ground-truth key provisions (e.g., ground-truth key provisions based on the same training resource documents). Based on the extent of differences between the plurality of predicted key provisions and the plurality of ground-truth key provisions, a loss can be generated. Further, parameters of the one or more machine-learning models can be modified in order to minimize the loss such that the accuracy of the one or more machine-learning models is increased (e.g., the accuracy of generating predicted key provisions that are similar to ground-truth key provisions). For example, resource data associated with a will can be inputted into the one or more machine-learning models, which can generate the one or more key provisions of the will (e.g., provisions associated with large dollar amounts and/or deadlines to claim assets of the estate) based on the resource data that was inputted.

Determining the one or more key provisions can comprise determining the one or more provisions associated with the one or more resource data fields or one or more resource data field values that satisfy one or more provision criteria associated with the one or more entities or the one or more resources. The one or more provision criteria can be based on one or more key events associated with the one or more entities or the one or more resources. For example, satisfying the one or more provision criteria can comprise one or more key events occurring (e.g., the return of a computing device to an organization or the birth of a child) or being within a predetermined period of time of the occurrence of one or more key events (e.g., a week before the scheduled return date for computing equipment or a year before the occurrence of a key event such as a beneficiary of a will reaching the age of majority).

The one or more key events can network system installation, network hardware reconfiguration, marriage, scheduled network maintenance, university graduation, an end of life date for computing devices, a return date (e.g., turn-in date) for computing devices, high-school graduation, divorce, receipt of a new asset (e.g., purchase of new computing devices, purchase of real property, or purchase of a vehicle including an automobile, airplane, or boat), start date of a new employee, termination date of an employee, birth of a child, and/or death of at least one of the one or more entities (e.g., death of a resource recipient).

The computing system can generate a resource profile. The resource profile can be based on the resource data. Further, the resource profile can comprise one or more indications. Further, the one or more indications can be associated with the one or more key provisions of the one or more resource documents. For example, the computing system can generate an interface (e.g., a graphical user interface) comprising one or more regions in which the one or more indications associated with the one or more key provisions of the one or more resource documents are displayed. Further, the resource profile can comprise one or more interface elements that can be configured to cause the computing system to generate information associated with one or more key provisions of the one or more resource documents based on detection of one or more inputs to the one or more interface elements.

The one or more indications can comprise text, numerical values, images, and/or symbols (e.g., graphs and/or charts) associated with the one or more key provisions associated with the resource data. The one or more indications can comprise identifiers and/or values associated with one or more key provisions. For example, the one or more indications can indicate one or more locations associated with the one or more key provisions (e.g., a geographical location associated with the resource data), one or more dates associated with the one or more key provisions (e.g., a date on which a contract or resource allocation document was signed), and/or one or more entities associated with the one or more key provisions (e.g., one or more entities including a resource manager, network administrator, systems architect, testator, beneficiary, executor, trustee, administrator, and/or asset manager).

In some embodiments, the one or more indications can comprise one or more interface elements that can generate information associated with one or more portions of the one or more key provisions and/or resource data based on detection of one or more inputs. For example, an interface element associated with a resource can be configured to show the name of a resource (e.g., a computing device or asset of an estate) by default and additional information about the resource such as the make and model of the resource based on detection of an input to the interface element. Further, the one or more indications can be updated in real-time or near real-time based on changes in the resource data and/or resource document data associated with the one or more key provisions (e.g., provisions that are added, modified, or deleted from a resource document).

The computing system can determine, based on inputting the resource data into the one or more machine-learning models, one or more predicted field values that correspond to the one or more resource data field values. The one or more machine-learning models can be configured and/or trained based on training data that can comprise historical data associated with the training field values that correspond to training fields. Further, the training data can comprise a plurality of ground-truth field values. Based on inputting the training data into the one or more machine-learning models, the one or more machine-learning models can generate a plurality of predicted resource data field values. The plurality of predicted resource data field values can be compared to a corresponding plurality of ground-truth field values (e.g., ground-truth field values based on the same training data). Based on the extent of differences between the plurality of predicted field values and the plurality of ground-truth field values, a loss can be generated. Further, parameters of the one or more machine-learning models can be modified in order to minimize the loss such that the accuracy of the one or more machine-learning models is increased (e.g., the accuracy of generating predicted field values that are similar to ground-truth field values). For example, resource data comprising resource data fields and resource data field values associated with a will can be inputted into the one or more machine-learning models, which can generate the one or more predicted field values (e.g., field values associated with signatures in a will or beneficiary names in a will) based on the resource data that was inputted.

The one or more machine-learning models can be configured and/or trained to determine one or more confidence values associated with the one or more predicted field values. The one or more indications can comprise the one or more confidence values. For example, the computing system can generate one or more confidence values associated with a predicted accuracy of the predicted field values. In some embodiments, the computing system can generate one or more indications to indicate the predicted field values that are associated with very high confidence values (e.g., 99% confidence) or very low confidence values (e.g., 5% confidence).

The computing system can generate one or more indications to emphasize the one or more resource data field values that do not match the one or more predicted field values. For example, the computing system can generate one or more indications comprising highlighting and/or underlining of the one or more resource data field values that do not match the one or more predicted field values. In some embodiments, the one or more indications can comprise the one or more predicted field values. For example, a predicted field value can be displayed alongside a corresponding field value and/or in place of a corresponding field value.

The one or more resource data field values can comprise a signature. For example, the one or more resource data field values can comprise the signature of a network administrator that authorizes users to access computing applications, the signature of a testator of an estate, and/or the signature of the beneficiary of an estate. Further, the one or more predicted field values can comprise a predicted signature. For example, the computing system can access samples of signatures associated with the same signatory and generate a predicted signature based on the samples. Further, the computing system can generate a text based (e.g., text based on fonts of the computing system that are displayed in an interface) version of predicted the signature.

The computing system can determine, based on the resource data, whether the one or more resource data field values satisfy one or more error criteria associated with one or more errors. For example, the computing system can compare the one or more resource data field values to one or more predicted field values and determine whether the one or more error criteria have been satisfied based on whether the one or more resource data field values match the one or more predicated field values. Satisfying the one or more error criteria can comprise the one or more resource data field values being associated with one or more misspellings, the one or more resource data field values comprising one or more resource values that are not within a resource value range, the one or more resource data field values comprising an invalid type of field value, and/or the one or more resource data field values comprising a null value (e.g., an empty field value).

The computing system can generate one or more indications to emphasize the one or more resource document field values that correspond to the one or more resource data field values that satisfy the one or more error criteria. For example, the computing system can highlight one or more portions of the one or more resource data fields and/or resource date field values that are determined to be misspelled.

The systems, methods, devices, computer-readable media (e.g., tangible non-transitory computer-readable media) in the disclosed technology can provide a variety of technical effects and benefits including an improvement in the generation of resource data associated with resource documents that can include indications associated with key provisions of the resource documents. Further, a personalized resource profile can be generated based on the resource data. The personalized resource profile can comprise indications that identify errors in field values of resource documents and/or predict field values in key provisions. The disclosed technology can provide the technical effect of improving the effectiveness with which resource document data is processed. For example, the computing system can be continuously updated based on updated resource document data, changes in the relationships between resources, and/or the identification of key events that may impact the way in which resources are distributed. In some embodiments, machine-learning models can be used in the process of generating a resource profile. Further, the machine-learning models can be continuously trained and/or updated in response to updated resource document data that is specific to the resources. As a result, a more relevant and timely resource profile that includes indications of key provisions of resource documents can be provided.

The disclosed technology can improve the operation of a resource processing device by more effectively performing a variety of tasks with the specific benefits of providing more accurate resources planning information. Further, the disclosed technology can use machine-learning models to more efficiently process resource documents that would otherwise require time consuming and burdensome manual review and handling. Accordingly, the improvements offered by the disclosed technology can result in tangible benefits to a variety of devices and/or systems comprising computing systems, electronic systems, and/or mechanical systems associated with processing resource data.

With reference to the Figures, example embodiments of the present disclosure will be discussed in further detail. FIG. 1 depicts a block diagram of an example environment including a computing system that performs operations according to example embodiments of the present disclosure. An environment 100 includes a network 102, a computing system 110, one or more computing devices 112, one or more processors 114, one or more memory devices 116, data 118, instructions 120, a remote computing system 130, one or more computing devices 132, one or more processors 134, one or more memory devices 136, data 138, instructions 140, one or more computing devices 152, one or more processors 154, one or more memory devices 156, data 158, and instructions 160.

The network 102 can include any type of communications network. For example, the network 102 can include a local area network (LAN), a wide area network (WAN), an intranet, an extranet, and/or the internet. Further, the network 102 can include any number of wired or wireless connections and/or links that can be used to communicate with one or more computing systems (e.g., the computing system 110 and/or the remote computing system 130) and/or one or more devices (e.g., the one or more computing devices 152). Communication over the network 102 can be performed via any type of wired and/or wireless connection and can use a wide variety of communication protocols (e.g., TCP/IP, HTTP, SMTP, FTP), encodings or formats (e.g., HTML, XML), and/or protection schemes (e.g., VPN, secure HTTP, SSL).

The computing system 110 can include any combination of systems and/or devices including one or more computing systems (not shown) and/or one or more computing devices 112. Further, the computing system 110 may be connected (e.g., networked) to one or more computing systems (e.g., remote computing system 130) and/or one or more computing devices (e.g., the one or more computing devices 152) via the network 102. The computing system 110 may operate in various different configurations including as a server or a client machine in a client-server network environment, or as a peer machine in a peer-to-peer (or distributed) network environment. Though the computing system 110 is depicted in FIG. 1 as a single device, the computing system 110 can include any collection or combination of devices that individually or in combination with other devices, execute a set of one or more instructions to perform any one or more of the operations discussed herein.

In this example, the computing system 110 includes one or more computing devices 112. The one or more computing devices 112 can include any type of computing device. For example, the one or more computing devices 112 can include a personal computing device (e.g., a desktop computing device), a mobile computing device (e.g., a smartphone or tablet device), a server computing device, a network router, a switch, a bridge, or any device capable of executing a set of instructions (e.g., any combination of instructions which can include sequential instructions and/or parallel instructions) associated with one or more operations and/or one or more actions to be performed by the computing system 110 or any of the constituent components and/or devices of the computing system 110.

Any of the one or more computing devices 112 can include the one or more processors 114. The one or more processors 114 can include any processing device (e.g., a processor core, a microprocessor, an ASIC, a FPGA, a controller, or a microcontroller) and can include one processor or multiple processors that may be operatively connected. In some embodiments, the one or more processors 114 may include one or more complex instruction set computing (CISC) microprocessors, one or more reduced instruction set computing (RISC) microprocessors, one or more very long instruction word (VLIW) microprocessors, and/or one or more processors that are configured to implement other instruction sets.

The one or more computing devices 112 can include the one or more memory devices 116. The one or more memory devices 116 can be used to store data and/or information and can include one or more computer-readable media, one or more non-transitory computer-readable storage media, and/or one or more machine-readable media. Though the one or more memory devices 116 are depicted in FIG. 1 as a single unit (e.g., a single medium), the computer-readable storage media can include a single medium or multiple media (e.g., a centralized or distributed database, and/or associated caches and servers) that store one or more sets of instructions. Further, the computer-readable storage media can include any medium that is capable of storing, encoding, and/or carrying a set of instructions for execution by a computing device and which may cause the computing device to perform any of the one or more operations described herein. In some embodiments, the computer-readable storage media can include one or more solid-state memories, one or more optical media, and/or one or more magnetic media. By way of example, the one or more memory devices 116 can include any combination of random-access memory (RAM), read-only memory (ROM), EEPROM, EPROM, one or more flash memory devices, and/or one or more magnetic storage devices (e.g., one or more hard disk drives).

The one or more processors 114 can be configured to execute one or more instructions to perform the operations described herein. Further, the one or more memory devices 116 can store the data 118 and/or the instructions 120, which can be executed by the one or more processors 114 to cause the one or more computing devices 112 to perform one or more operations. For example, the one or more operations performed by the one or more processors 114 can include accessing resource document data and/or resource data.

The data 118 can include resource document data and/or resource data. Further, the instructions 120 can include one or more instructions to use data including the data 118 to perform any one or more of the various operations described herein. In some embodiments, the one or more memory devices 116 can be used to store one or more applications that can be operated by the one or more processors 114. The data 118, the instructions 120, and/or the one or more applications can be associated with processing and/or allocating resources. Further, the computing system 110 may be associated with processing and/or allocating and may be configured to manage one or more applications.

Any of the one or more computing devices 112 can include one or more input devices 122 and/or one or more output devices 124. The one or more input devices 122 can be configured to receive input (e.g., user input) and can include one or more touch screens, one or more keyboards, one or more pointing devices, (e.g., mouse device), one or more buttons, one or more microphones, and/or one or more cameras. The one or more output devices 124 can include one or more display devices, one or more loudspeaker devices, one or more haptic output devices. By way of example, the one or more output devices 124 can be used to display a graphical user interface via a display device that can include a touch screen layer that is configured to detect one or more inputs (e.g., one or more user inputs). The one or more processors 114 may perform one or more operations based at least in part on the one or more inputs.

The remote computing system 130 includes one or more computing devices 132. Each of the one or more computing devices 132 can include one or more processors 134, one or more memory devices 136, the data 138, and/or the instructions 140. The remote computing system 130 can include any of the attributes and/or capabilities of the computing system 110. Further, the remote computing system 130 can communicate with one or more devices and/or one or more systems via the network 102. In some embodiments, the remote computing system 130 can include one or more applications (e.g., computer software applications comprising computer instructions) that can be stored and/or executed by the remote computing system 130.

One or more computing devices 152 (e.g., user devices or any other types of devices) can include one or more processors 154, one or more memory devices 156, the data 158, and/or the instructions 160. The one or more computing devices 152 may include any of the attributes and/or capabilities of the one or more computing devices 112, and/or the one or more computing devices 132. Further, the one or more computing devices 152 can communicate with one or more devices and/or one or more systems via the network 102. In some embodiments, the one or more computing devices 152 can include one or more applications (e.g., computer software applications comprising computer instructions) that can be stored and/or executed by the one or more computing devices 152.

FIG. 2 depicts a block diagram of an example of a computing device according to example embodiments of the present disclosure. A computing device 200 can include one or more attributes and/or capabilities of the computing system 110, the remote computing system 130, the one or more computing devices 152, and/or the computing device 200. Furthermore, the computing device 200 can be configured to perform one or more operations and/or one or more actions that can be performed by the computing system 110, the remote computing system 130, the one or more computing devices 152, and/or the computing device 200.

As shown in FIG. 2, the computing device 200 can include one or more memory devices 202, including resource data 204, resource document data 206, network data 207, key provision data 208, one or more machine-learning models 209, one or more interconnects 214, one or more processors 220, a network interface 222, one or more mass storage devices 224, one or more output devices 226, and/or one or more input devices 228.

The one or more memory devices 202 can store information and/or data (e.g., resource data 204, and/or any other types of data). Further, the one or more memory devices 202 can include one or more non-transitory computer-readable storage media, including RAM, ROM, EEPROM, EPROM, flash memory devices, magnetic disks, and any combination thereof. The information and/or data stored by the one or more memory devices 202 can be executed by the one or more processors 220 to cause the computing device 200 to perform one or more operations described herein. The resource data 204, the resource document data 206, the key provision data 208, the one or more machine-learning models 209, and/or other data stored in the one or more memory devices 202 can be encrypted for added security.

The resource data 204 can include one or more portions of data (e.g., the data 118, the data 138, and/or the data 158, which are depicted in FIG. 1) and/or instructions (e.g., the instructions 120, the instructions 140, and/or the instructions 160, which are depicted in FIG. 1) that are stored respectively in any of the one or more memory devices 116, 136, 156. The resource data 204 also can include information associated with one or more resource documents, one or more entities (e.g., resource recipients, trustees, and/or executors), the resource document data 206, and/or one or more resources. For example, the resource data 204 can include resource document data and/or resource data obtained and/or received from one or more clients.

The resource document data 206 can include one or more portions of data (e.g., the data 118, the data 138, and/or the data 158, which are depicted in FIG. 1) and/or instructions (e.g., the instructions 120, the instructions 140, and/or the instructions 160, which are depicted in FIG. 1) that are stored respectively in any of the one or more memory devices 116, 136, 156. The resource document data 206 can include information associated with one or more resource documents that can be associated with resource allocation instructions and/or the resource data 204. For example, the resource document data 206 can include information based on one or more resource documents associated with a network policy. By way of further example, the resource document data 206 can include information based on one or more resource documents associated with an estate plan.

The network data 207 can include one or more portions of data (e.g., the data 118, the data 138, and/or the data 158, which are depicted in FIG. 1) and/or instructions (e.g., the instructions 120, the instructions 140, and/or the instructions 160, which are depicted in FIG. 1) that are stored respectively in any of the one or more memory devices 116, 136, 156. The network data 207 can include information associated with one or more network devices (e.g., computing devices of a network, routers, and/or switches) that can be associated with resource allocation instructions. For example, the network data 207 can include information associated with network architecture that can be used to determine the way in which assets and/or instructions associated with network resources are distributed to users of the associated network.

The key provision data 208 can include one or more portions of data (e.g., the data 118, the data 138, and/or the data 158, which are depicted in FIG. 1) and/or instructions (e.g., the instructions 120, the instructions 140, and/or the instructions 160, which are depicted in FIG. 1) that are stored respectively in any of the one or more memory devices 116, 136, 156. Further, the key provision data 208 can include information associated with one or more key provisions associated with one or more resource document and/or resource data. For example, the key provision data 208 can comprise information associated with one or more key provisions of a device allocation policy. By way of further, example, the key provision data 208 can comprise information associated with one or more key provisions of an estate plan or will.

In some implementations, the computing device 200 can store the one or more machine-learning models 209 that can include one or more resource document processing models. In some embodiments, the one or more machine-learning model can include one or more machine-learning models that are specifically configured and/or trained to generate and/or process the resource data 204, the resource document data 206, and/or the key provision data 208.

For example, the one or more machine-learning models 209 can be or can otherwise include various machine-learning models such as neural networks (e.g., deep neural networks) or other types of machine-learning models, including non-linear models and/or linear models. Neural networks can include feed-forward neural networks, recurrent neural networks (e.g., long short-term memory recurrent neural networks), convolutional neural networks or other forms of neural networks. Some example machine-learning models can leverage an attention mechanism such as self-attention. For example, some example machine-learning models can include multi-headed self-attention models (e.g., transformer models). In some embodiments, the one or more machine-learning models 209 can comprise one or more large language models (LLMs).

In some implementations, the input to the one or more machine-learning models 209 (e.g., machine-learning models) of the present disclosure can comprise statistical data. Statistical data can be, represent, or otherwise include data computed and/or calculated from some other data source. The one or more machine-learning models 209 can process the statistical data to generate an output. As an example, the one or more machine-learning models 209 can process the statistical data to generate a threshold value for a metric. As another example, the one or more machine-learning models 209 can process the statistical data to generate a prediction output (e.g., one or more predicted resource data field values).

The one or more interconnects 214 can include one or more interconnects or buses that can be used to send and/or receive one or more signals (e.g., electronic signals) and/or data (e.g., resource data 204 and/or any other data) between components of the computing device 200, including the one or more memory devices 202, the one or more processors 220, the network interface 222, the one or more mass storage devices 224, the one or more output devices 226, and/or the one or more input devices 230. The one or more interconnects 214 can be arranged or configured in different ways. For example, the one or more interconnects 214 can be configured as parallel or serial connections. Further the one or more interconnects 214 can include one or more internal buses that are used to connect the internal components of the computing device 200 and one or more external buses used to connect the internal components of the computing device 200 to one or more external devices. By way of example, the one or more interconnects 214 can include different interfaces including Industry Standard Architecture (ISA), Extended ISA, Peripheral Components Interconnect (PCI), PCI Express, Serial AT Attachment (SATA), HyperTransport (HT), USB (Universal Serial Bus), Thunderbolt, IEEE 1394 interface (FireWire), and/or other interfaces that can be used to connect components.

The one or more processors 220 can include one or more computer processors that are configured to execute the one or more instructions stored in the one or more memory devices 202. For example, the one or more processors 220 can, for example, include one or more general purpose central processing units (CPUs), application specific integrated circuits (ASICs), one or more neural processing units (NPUs), and/or one or more graphics processing units (GPUs). Further, the one or more processors 220 can perform one or more actions and/or operations including one or more actions and/or operations associated with the resource data 204, the resource document data 206, the key provision data 208, and/or any other data. The one or more processors 220 can include single or multiple core devices including a microprocessor, microcontroller, integrated circuit, and/or a logic device.

The network interface 222 can support network communications. The network interface 222 can support communication via networks including a local area network and/or a wide area network (e.g., the internet). For example, the network interface 222 can allow the computing device 200 to communicate with the computing system 110 via the network 102.

The one or more mass storage devices 224 (e.g., a hard disk drive and/or a solid-state drive) can be used to store data including the resource data 204 and one or more machine-learning models 209, and/or any other data. The one or more output devices 226 can include one or more display devices (e.g., liquid crystal display (LCD), OLED display, mini-LED display, micro-LED display, plasma display, and/or cathode ray tube (CRT) display), one or more light sources (e.g., LEDs), one or more loudspeakers, and/or one or more haptic output devices (e.g., one or more devices that are configured to generate vibratory output).

The one or more input devices 228 can include one or more touch sensitive devices (e.g., a touch screen display), a mouse, a stylus, one or more keyboards, one or more buttons (e.g., ON/OFF buttons and/or YES/NO buttons), one or more microphones, and/or one or more cameras (e.g., cameras that are used to detect gestures that can trigger one or more operations by the computing device 200). Further, the one or more input devices 228 can be used to provide input (e.g., a response to a prompt associated with resource data and/or resource document data) that can be used as part of invoking or performing one or more operations. For example, the one or more input devices 228 can receive one or more inputs from a user (e.g., a resource advisor, wealth advisor, financial planner, and/or resource strategist) associated with entering data in response to one or more prompts associated with resource data and generated by the computing device 200.

Although the one or more memory devices 202 and the one or more mass storage devices 224 are depicted separately in FIG. 2, the one or more memory devices 202 and the one or more mass storage devices 224 can be regions within the same memory module. The computing device 200 can include one or more additional processors, memory devices, and/or network interfaces, which may be provided separately or on the same chip or board. The one or more memory devices 202 and the one or more mass storage devices 224 can include one or more computer-readable media, including, but not limited to, non-transitory computer-readable media, RAM, ROM, hard drives, flash drives, and/or other memory devices.

The one or more memory devices 202 can store sets of instructions for applications including an operating system that can be associated with various software applications or data. For example, the one or more memory devices 202 can store sets of instructions for one or more applications (e.g., one or more resources planning applications and/or one or more third-party applications) that can be configured, generated, and/or implemented by the computing device 200 and/or one or more other computing devices or one or more computing systems. In some embodiments, the one or more memory devices 202 can be used to operate or execute a general-purpose operating system that operates on mobile computing devices and/or and stationary devices, including for example, smartphones, laptop computing devices, tablet computing devices, and/or desktop computers.

The software applications that can be operated or executed by the computing device 200 can include applications associated with the computing system 110, the remote computing system 130, and/or the one or more computing devices 152 that are depicted in FIG. 1. Further, the software applications that can be operated and/or executed by the computing device 200 can include native applications, web services, and/or web-based applications.

FIG. 3 depicts a diagram of an example machine-learning model according to example embodiments of the present disclosure. The machine-learning model described with respect to FIG. 3 can be generated, implemented, configured, and/or trained by a computing system or computing device that includes one or more features of the computing system 110, the remote computing system 130, and/or the one or more computing devices 152, which are described with respect to FIG. 1; and/or the computing device 200 that is described with respect to FIG. 2. As shown in FIG. 3, the machine-learning system 300 includes training data 302, one or more machine-learning models 304, and output 306.

The training data 302 can comprise training resource document data that can comprise information associated with one or more resource documents, one or more resources, one or more resource allocation instructions, one or more entities, one or more provisions, and/or one or more key provisions. The training resource data can be based on historical data (e.g., data based on actual historical resource documents, historical entities, and/or actual historical resources). Further, the training data 302 can comprise training network data that can comprise information associated with configurations of computing networks. For example, the training data 302 can indicate the devices and device configurations (e.g., software configurations, processor configurations, memory configurations, and/or storage configurations of computing devices) associated with a network. The training data 302 can comprise training estate data that can comprise information associated with training estates, training estate entities (e.g., trustees, beneficiaries, and/or testator's), training estate resources (e.g., assets comprising real property, stocks, vehicles, cash, and/or tangible personal property), and/or training estate resource documents.

The one or more machine-learning models 304 can be configured and/or trained using supervised learning, unsupervised learning, reinforcement learning, and/or semi-supervised learning. Further, the one or more machine-learning models may use one or more algorithms and/or machine-learning structures including one or more generative adversarial models (GANs), one or more large language models (LLMs), one or more generative models, one or more neural networks (e.g., convolutional neural networks), random forest, one or more decision trees, nearest neighbors, linear regression, logistic regression, K Means clustering, and/or one or more support vector machines. Additionally, the one or more machine-learning models can be configured to operate individually and/or in combination with one or more other machine-learning models of the one or more machine-learning models 304.

The one or more machine-learning models 304 can comprise a plurality of parameters associated with a plurality of weights that can be modified as the one or more machine-learning models 304 are configured and/or trained. Configuring and/or training the one or more machine-learning models 304 can comprise modifying the weights associated with the plurality of parameters based on how much each of the plurality of parameters contributes to increasing or decreasing the accuracy of output generated by the one or more machine-learning models 304. The accuracy of the output generated by the one or more machine-learning models 304 can be associated with error. For example, the accuracy of the output of the one or more machine-learning models 304 can be inversely correlated with the error such that higher accuracy corresponds to low error and low accuracy corresponds to high error.

For example, the one or more machine-learning models 304 can comprise a plurality of parameters corresponding to a plurality of resources associated with a plurality of resource fields and corresponding plurality of resource field values. In the process of training the one or more machine-learning models 304, the weighting of the plurality of parameters can be modified based on the extent to which each of the plurality of parameters contributes to accurately predicting the resource field values of the plurality of resources.

Configuring and/or training the one or more machine-learning models 304 can comprise the use of a cost function that can be used to minimize the cost of output of the one or more machine-learning models 304 and/or an error function that can be used to minimize the error (e.g., inaccuracy) of the output of the one or more machine-learning models 304 with respect to a plurality of ground truth values corresponding to accurate output. For example, the training data can comprise a plurality of predicted key provisions associated with a plurality of resource documents associated with resource data and/or resource document data. The plurality of ground-truth data may indicate values associated with actual asset distributions. Accurate output by the one or more machine-learning models 304 can comprise accurately generating predicted key provisions that are similar to ground-truth key provisions. Inaccurate output by the one or more machine-learning models 304 can comprise not accurately generating predicted key provisions that are not similar to ground-truth key provisions. As the one or more machine-learning models 304 are configured and/or trained, the weighting of the plurality of parameters of the one or more machine-learning models 304 can be modified until the error associated with the output of the one or more machine-learning models 304 is minimized to a predetermined level (e.g., a level associated with generating output that is at least 98% accurate). Configuring and/or training the one or more machine-learning models 304 can be performed over a plurality of rounds and/or iterations. Further, configuring and/or training the one or more machine-learning models 304 can end when a predetermined level of accuracy of the one or more machine-learning models 304 is achieved. Additionally, the one or more machine-learning models 304 can be periodically retrained based on updated training data. For example, additional training data based on new historical data associated with additional resource documents and/or resources can be added to the training data. Further, synthetic training data based on historical training data can be generated using one or more synthetic data generation techniques in which the synthetic training data can have statistical properties that are similar to the statistical properties of actual historical data.

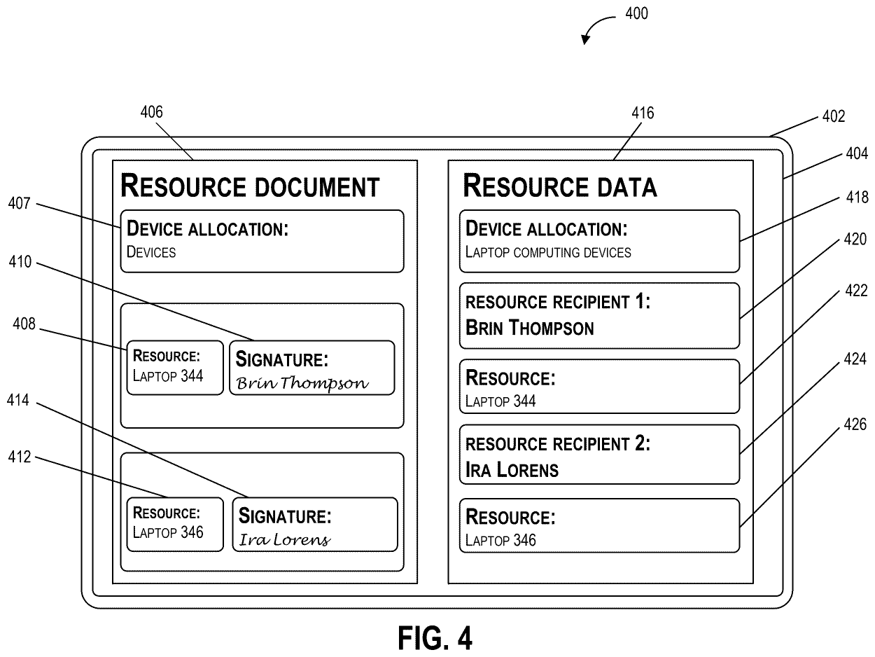

FIG. 4 depicts an example of an interface for resource document data and resource data according to example embodiments of the present disclosure. A computing device 400 can include one or more attributes and/or capabilities of the computing system 110, the remote computing system 130, the one or more computing devices 152, and/or the computing device 200. Furthermore, the computing device 400 can be configured to perform one or more operations and/or one or more actions that can be performed by the computing system 110, the remote computing system 130, the one or more computing devices 152, and/or the computing device 200.

As shown in FIG. 4, the computing device 400 includes a display component 402, an interface 404, a resource document region 406, an interface element 407, an interface element 408, an interface element 410, and an interface element 412, an interface element 414, a resource data region 416, an interface element 418, an interface element 420, and an interface element 422.

The computing device 400 can include the display component 402 which can be configured to generate output comprising the interface (e.g., a graphical user interface) and content related to resource data (e.g., an asset allocation) that can be displayed on the interface 404. The interface 404 can comprise the resource document region 406 and the resource data region 416. The output generated by the computing device 400 can comprise an asset distribution for a plurality of assets to a plurality of resource recipients (e.g., two assets that are distributed to two resource recipients). For example, the computing device 400 can access resource data that indicates the assets associated with resource allocation instructions, the resource recipients of the resources, and/or the resource allocation instructions which include indicate the distribution of the assets to the resource recipients.

The computing device 400 can access resource document data associated with a plurality of resource documents (e.g., the documents associated with an estate plan for an estate) the assets, resource recipients, and/or resource allocation instructions that indicate the allocation of resources (e.g., assets) to the resource recipients and display information associated with the allocation of assets. Further, the computing device 400 can access and/or generate resource data that is based on the resource document data. For example, the computing device 400 can generate resource data based on the performance of one or more operations that detect, recognize, and/or classify one or more portions of one or more resource documents associated with the resource document data. Further, the computing device 400 can retrieve the resource document data and/or resource data from a remote computing device.

In this example, the interface 404 can comprise information associated with resource document data. The information associated with the resource document data can be displayed in the resource document region 406. The resource document region 406 comprises the interface element 407 which indicates (“ASSET ALLOCATION: ESTATE ASSETS”). The interface element 407 can indicate one or more types of resources (e.g., assets of an estate) that are being allocated to resource recipients (e.g., beneficiaries of the estate). The resource document region 406 comprises the interface element 408 (“RESOURCE: LAPTOP 344”) which can indicate a resource document data field (“RESOURCE”) and corresponding resource document data field value (e.g., “LAPTOP 344”). The interface element 408 can be associated with the interface element 410 which can indicate a document data field (“SIGNATURE”) associated with a signature of a resource recipient (“BRIN THOMPSON”). In this example, the interface element 410 can indicate that the resource recipient has taken possession of the resource (e.g., an asset that has a value of “LAPTOP 344”).

Further, the resource document region 406 comprises the interface element 412 (“RESOURCE: LAPTOP 346”) which can indicate a resource document data field (“RESOURCE”) and corresponding resource document data field value (e.g., “LAPTOP 346”). The interface element 412 can be associated with the interface element 414 which can indicate a document data field (“SIGNATURE”) associated with a signature of another resource recipient (“IRA LORENS”). In this example, the interface element 414 can indicate that the resource recipient has taken possession of the resource (e.g., an asset that has a value of “LAPTOP 346”). In some embodiments, the same resource recipient can be associated with different resources (e.g., a beneficiary of an estate who inherits a house and an automobile). Further, the same resources can be associated with different resource recipients (e.g., two beneficiaries of an estate that are bequeathed equal shares of the same real property asset).

The interface 404 can comprise information associated with resource data. The information associated with resource data can be displayed in the resource data region 416. Further, the resource data region 416 can comprise the interface element 418 which indicates (“ESTATE ALLOCATION: LAPTOP COMPUTING DEVICES”). The interface element 418 can indicate one or more types of resources (e.g., Laptop Computing Devices assets of an estate) that are being allocated to resource recipients (e.g., beneficiaries of the estate). The content of the interface elements 418-426 can be based on output from one or more machine-learning models that are configured to recognize and/or classify the one or more resource documents associated with the interface elements in the resource document region 406. The resource data region 416 can comprise the interface element 420 (“RESOURCE RECIPIENT: BRIN THOMPSON”) which can indicate a resource data field (“RESOURCE RECIPIENT”) and corresponding resource data field value (e.g., BRIN THOMPSON”). The resource data associated with the interface element 420 can be based on the resource document data corresponding to the interface element 410 (“SIGNATURE: BRIN THOMPSON”). The computing device 400 can generate the resource data associated with the interface element 420 based on performing one or more handwriting recognition and/or one or more classification operations on the resource document data associated with the signature indicated in the interface element 410. The interface element 422 can comprise resource data based on the resource document data associated with the interface element 408 (“LAPTOP 344”).

Further, the resource data region 416 can comprise the interface element 424 (“RESOURCE RECIPIENT: IRA LORENS”) which can indicate a resource data field (“RESOURCE RECIPIENT”) and corresponding resource data field value (e.g., IRA LORENS”). The resource data associated with the interface element 424 can be associated with the resource document data corresponding to the interface element 414 (“SIGNATURE: IRA LORENS”). The computing device 400 can generate the resource data associated with the interface element 424 based on performing one or more handwriting recognition and/or one or more classification operations on the resource document data associated with the signature indicated in the interface element 412. The interface element 426 can comprise resource data based on the resource document data associated with the interface element 408 (“LAPTOP 346”).

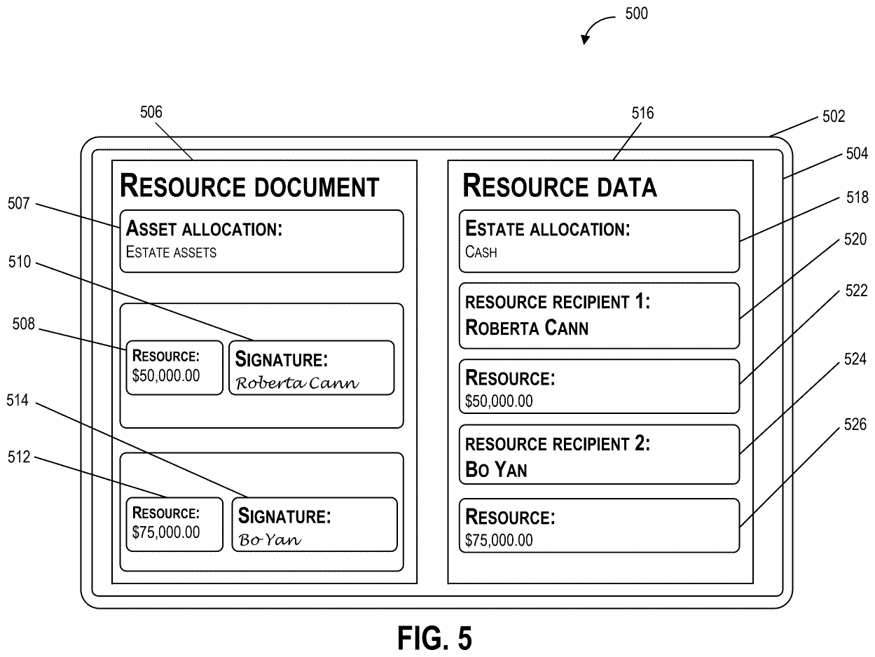

FIG. 5 depicts an example of an interface for resource document data and resource data according to example embodiments of the present disclosure. A computing device 500 can include one or more attributes and/or capabilities of the computing system 110, the remote computing system 130, the one or more computing devices 152, and/or the computing device 200. Furthermore, the computing device 500 can be configured to perform one or more operations and/or one or more actions that can be performed by the computing system 110, the remote computing system 130, the one or more computing devices 152, and/or the computing device 200.

As shown in FIG. 5, the computing device 500 includes a display component 502, an interface 504, a resource document region 506, an interface element 507, an interface element 508, an interface element 510, and an interface element 512, an interface element 514, a resource data region 516, an interface element 518, an interface element 520, and an interface element 522.

The computing device 500 can include the display component 502 which can be configured to generate output comprising the interface (e.g., a graphical user interface) and content related to resource data (e.g., an asset allocation) that can be displayed on the interface 504. The interface 504 can comprise the resource document region 506 and the resource data region 516. The output generated by the computing device 500 can comprise an asset distribution for a plurality of assets to a plurality of resource recipients (e.g., two assets that are distributed to two resource recipients). For example, the computing device 500 can access resource data that indicates the assets associated with resource allocation instructions, the resource recipients of the resources, and/or the resource allocation instructions which include indicate the distribution of the assets to the resource recipients.

The computing device 500 can access resource document data associated with a plurality of resource documents (e.g., the documents associated with an estate plan for an estate) the assets, resource recipients, and/or resource allocation instructions that indicate the allocation of resources (e.g., assets) to the resource recipients and display information associated with the allocation of assets. Further, the computing device 500 can access and/or generate resource data that is based on the resource document data. For example, the computing device 500 can generate resource data based on the performance of one or more operations that detect, recognize, and/or classify one or more portions of one or more resource documents associated with the resource document data. Further, the computing device 500 can retrieve the resource document data and/or resource data from a remote computing device.

In this example, the interface 504 can comprise information associated with resource document data. The information associated with the resource document data can be displayed in the resource document region 506. The resource document region 506 comprises the interface element 507 which indicates (“ASSET ALLOCATION: ESTATE ASSETS”). The interface element 507 can indicate one or more types of resources (e.g., assets of an estate) that are being allocated to resource recipients (e.g., beneficiaries of the estate). The resource document region 506 comprises the interface element 508 (“RESOURCE: $50,000.00”) which can indicate a resource document data field (“RESOURCE”) and corresponding resource document data field value (e.g., “$50,000.00”). The interface element 508 can be associated with the interface element 510 which can indicate a document data field (“SIGNATURE”) associated with a signature of a resource recipient (“ROBERTA CANN”). In this example, the interface element 510 can indicate that the resource recipient has taken possession of the resource (e.g., an asset that has a value of “$50,000.00”).

Further, the resource document region 506 comprises the interface element 512 (“RESOURCE: $75,000.00”) which can indicate a resource document data field (“RESOURCE”) and corresponding resource document data field value (e.g., “$75,000.00”). The interface element 512 can be associated with the interface element 514 which can indicate a document data field (“SIGNATURE”) associated with a signature of another resource recipient (“BO YAN”). In this example, the interface element 514 can indicate that the resource recipient has taken possession of the resource (e.g., an asset that has a value of “$75,000.00”). In some embodiments, the same resource recipient can be associated with different resources (e.g., a beneficiary of an estate who inherits a house and an automobile). Further, the same resources can be associated with different resource recipients (e.g., two beneficiaries of an estate that are bequeathed equal shares of the same real property asset).

The interface 504 can comprise information associated with resource data. The information associated with resource data can be displayed in the resource data region 516. Further, the resource data region 516 can comprise the interface element 518 which indicates (“ESTATE ALLOCATION: CASH”). The interface element 518 can indicate one or more types of resources (e.g., cash assets of an estate) that are being allocated to resource recipients (e.g., beneficiaries of the estate). The content of the interface elements 518-526 can be based on output from one or more machine-learning models that are configured to recognize and/or classify the one or more resource documents associated with the interface elements in the resource document region 506. The resource data region 516 can comprise the interface element 520 (“RESOURCE RECIPIENT: ROBERTA CANN”) which can indicate a resource data field (“RESOURCE RECIPIENT”) and corresponding resource data field value (e.g., ROBERTA CANN”). The resource data associated with the interface element 520 can be based on the resource document data corresponding to the interface element 510 (“SIGNATURE: ROBERTA CANN”). The computing device 500 can generate the resource data associated with the interface element 520 based on performing one or more handwriting recognition and/or one or more classification operations on the resource document data associated with the signature indicated in the interface element 510. The interface element 522 can comprise resource data based on the resource document data associated with the interface element 508 (“$50,000.00”).

Further, the resource data region 516 can comprise the interface element 524 (“RESOURCE RECIPIENT: BO YAN”) which can indicate a resource data field (“RESOURCE RECIPIENT”) and corresponding resource data field value (e.g., BO YAN”). The resource data associated with the interface element 524 can be associated with the resource document data corresponding to the interface element 514 (“SIGNATURE: BO YAN”). The computing device 500 can generate the resource data associated with the interface element 524 based on performing one or more handwriting recognition and/or one or more classification operations on the resource document data associated with the signature indicated in the interface element 512. The interface element 526 can comprise resource data based on the resource document data associated with the interface element 508 (“$75,000.00”).

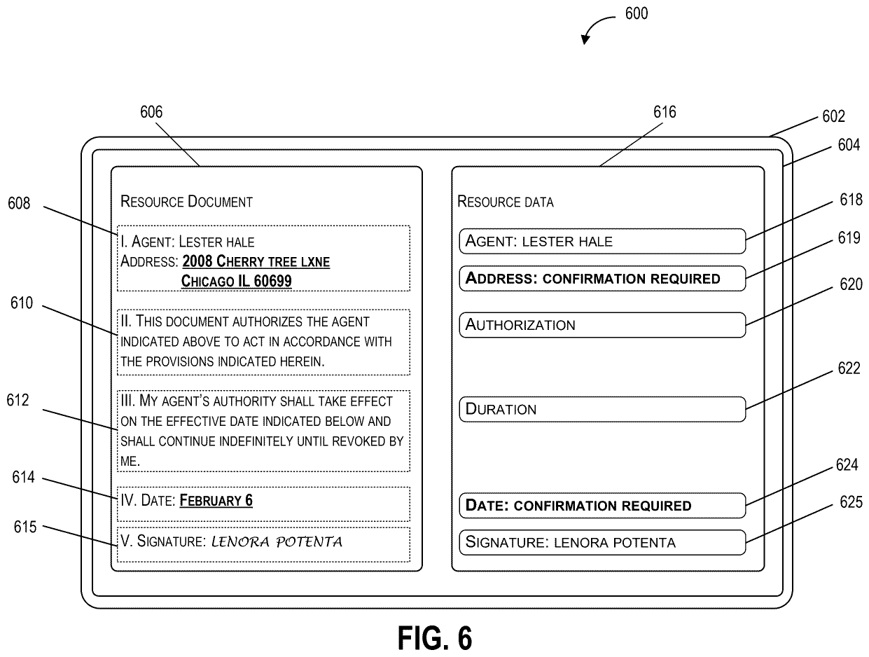

FIG. 6 depicts an example of an interface for resource document data and resource data according to example embodiments of the present disclosure. A computing device 600 can include one or more attributes and/or capabilities of the computing system 110, the remote computing system 130, the one or more computing devices 152, and/or the computing device 200. Furthermore, the computing device 600 can be configured to perform one or more operations and/or one or more actions that can be performed by the computing system 110, the remote computing system 130, the one or more computing devices 152, and/or the computing device 200.

As shown in FIG. 6, the computing device 600 includes a display component 602, an interface 604, a resource document region 606, an interface element 608, an interface element 610, and an interface element 612, an interface element 614, an interface element 615, a resource data region 616, an interface element 618, an interface element 619, an interface element 620, an interface element 22, an interface element 624, and an interface element 625.

The computing device 600 can include the display component 602 which can be configured to generate output comprising the interface (e.g., a graphical user interface) and content related to resource data (e.g., a resource allocation) that can be displayed on the interface 604. The interface 604 can comprise the resource document region 606 and the resource data region 616. The output generated by the computing device 600 can comprise a plurality of provisions of a resource document associated with resource document data. The computing device 600 can access resource document data that indicates some provisions of a resource document that is associated with the allocation of resources to one or more resource recipients.

The computing device 600 can access resource document data associated with one or more resource documents (e.g., the resource documents associated with a device allocation plan, the resource documents associated with a network policy, and/or resource documents associated with an estate plan for an estate) the assets, resource recipients, and/or resource allocation instructions that indicate the allocation of resources (e.g., assets comprising computing devices, network resources, or assets of an estate) to the resource recipients. Further, the computing device 600 can display information associated with the one or more provisions of one or more resource documents in the resource document region 606. The computing device 600 can access and/or generate resource data that is based on the resource document data. For example, the computing device 600 can generate resource data based on the performance of one or more operations that detect, recognize, and/or classify one or more portions of one or more resource documents associated with the resource document data. Further, the computing device 600 can retrieve the resource document data and/or resource data from a remote computing device.

In this example, the interface 604 can display information associated with resource document data and resource data. The information associated with resource document data based on one or more provisions of a resource document can be displayed in the resource document region 606. The resource document region 606 comprises the interface element 608 which is based on resource document data fields and resource document data field values associated with the name and address of an agent associated with the allocation of one or more resources (e.g., a network administrator or an estate administrator”). Further, the interface element 608 indicates the name of an agent associated with a first provision of a resource document (“AGENT: LESTER HALE”) and the address of the agent (“ADDRESS: 2008 CHERRY TREE LANE CHICAGO Ill. 60699”).

The resource document region 606 comprises the interface element 610 which is based on resource document data fields and resource document data field values associated with the name and address of an agent associated with the allocation of one or more resources (e.g., a network administrator or an estate administrator”). Further, the interface element 610 indicates the name of an agent associated with a first provision of a resource document (“THIS DOCUMENT AUTHORIZES THE AGENT INDICATED ABOVE TO ACT IN ACCORDANCE WITH THE PROVISIONS INDICATED HEREIN.”).

The resource document region 606 comprises the interface element 612 which is based on resource document data fields and resource document data field values associated with the name and address of an agent associated with the allocation of one or more resources (e.g., a network administrator or an estate administrator”). Further, the interface element 612 indicates the name of an agent associated with a first provision of a resource document (“MY AGENT'S AUTHORITY SHALL TAKE EFFECT ON THE EFFECTIVE DATE INIDCATED BELOW AND SHALL CONTINUE INDEFINITELY UNTIL REVOKED BY ME”).

The resource document region 606 comprises the interface element 614 which is based on resource document data fields and resource document data field values associated with the name and address of an agent associated with the allocation of one or more resources (e.g., a network administrator or an estate administrator”). Further, the interface element 614 indicates the name of an agent associated with a first provision of a resource document (“DATE:”) and the address of the agent (“FEBRUARY 6”).

The resource document region 606 comprises the interface element 615 which is based on resource document data fields and resource document data field values associated with the name and address of an agent associated with the allocation of one or more resources (e.g., a network administrator or an estate administrator”). Further, the interface element 615 indicates the name of an agent associated with a first provision of a resource document (“SIGNATURE”) and the address of the agent (“LENORA POTENTA”).

The interface 604 can comprise information associated with resource data. The information associated with resource data can be displayed in the resource data region 616. Further, the resource data region 616 can comprise the interface element 618 (“AGENT: LESTER HALE”) which can indicate a resource data field (“AGENT”) and corresponding resource data field value (e.g., “LESTER HALE”). The resource data associated with the interface element 618 can be based on the resource document data corresponding to the interface element 608, which indicates the name and address of the agent associated with the resource document displayed in the resource document region 606. Further, the resource data region 616 can comprise the interface element 620 (“ADDRESS: CONFIRMATION REQUIRED”) which can be associated with the resource document data corresponding to the interface element 608. The computing device 600 can determine that the resource document data associated with the interface element 608 has satisfied one or more error criteria. In this example, the computing device 600 can determine that the address (e.g., “CHERRY TREE LXNE” may be a misspelling of “CHERRY TREE LANE”) has satisfied one or more error criteria based on the detection of the misspelling. Further, the computing device 600 can generate one or more indications to emphasize one or more portions of the resource document data that satisfy the one or more error criteria. For example, the computing device 600 has underlined the address (“2008 CHERRY TREE LANE CHICAGO Ill. 60699”) and modified the appearance of the address to have a bold font.

Further, the resource data region 616 can comprise the interface element 620 (“AUTHORIZATION”) which can indicate a resource data field (“AUTHORIZATION”) based on the resource document data associated with the resource document data corresponding to the interface element 610, which indicates that the resource document authorizes an agent to act in accordance with the provisions of the resource document. In some embodiments, the interface element 620 can be configured to display additional information comprising the resource document data indicated in the interface element 610.

Further, the resource data region 616 can comprise the interface element 622 (“DURATION”) which can indicate a resource data field (“DURATION”) based on the resource document data associated with the resource document data corresponding to the interface element 612, which indicates that the duration of the agent's authority. In some embodiments, the interface element 622 can be configured to display additional information comprising the resource document data indicated in the interface element 610.

The resource data region 616 can comprise the interface element 624 (“DATE: CONFIRMATION REQUIRED”) which can be associated with the resource document data corresponding to the interface element 614. The computing device 600 can determine that the resource document data associated with the interface element 608 has satisfied one or more error criteria. In this example, the computing device 600 can determine that the date (e.g., “FEBRUARY 6” may be incomplete and that the absence of a year (e.g., the year that the resource document was signed) in the resource document field value has satisfied one or more error criteria based on the detection of the misspelling.

Further, the resource data region 616 can comprise the interface element 625 (“SIGNATURE: LENORA POTENTA”) which can indicate a resource data field (“SIGNATURE”) and corresponding resource data field value (e.g., “LENORA POTENTA”). The resource data associated with the interface element 625 can be based on the resource document data corresponding to the interface element 615, which indicates the name of the signatory of the resource document displayed in the resource document region 606.

The computing device 600 can generate the resource data associated with the interface element 625 based on performing one or more handwriting recognition and/or one or more classification operations on the resource document data associated with the signature indicated in the interface element 615.

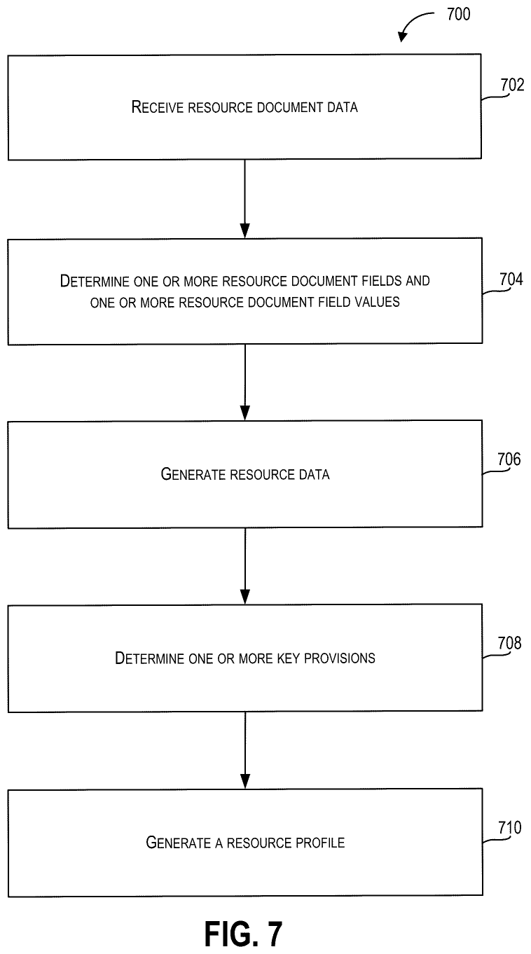

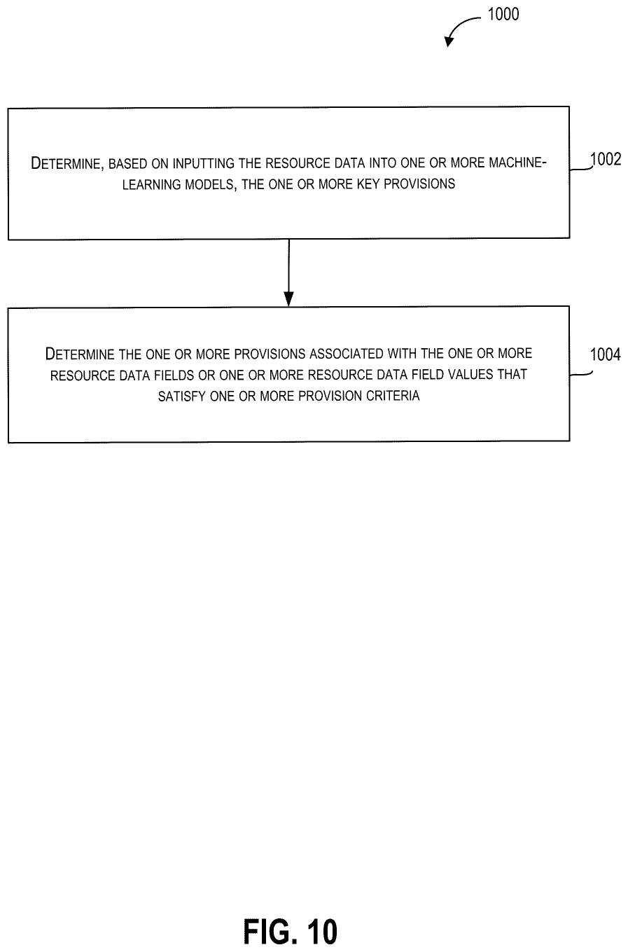

FIG. 7 depicts a flow diagram of generating resource data according to example embodiments of the present disclosure. One or more portions of the method 1000 can be executed and/or implemented on one or more computing devices or computing systems including, for example, the computing system 110, the remote computing system 130, the one or more computing devices 152, and/or the computing device 200. Further, one or more portions of the method 1000 can be executed or implemented as an algorithm on the hardware devices or systems disclosed herein. FIG. 10 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 702, the method 700 can include receiving resource document data comprising one or more resource documents associated with resource allocation instructions for distribution of one or more resources to one or more entities. For example, the computing system 110 can receive data comprising resource document data associated with a network policy and the devices and/or network protocols of the network policy. Further, the resource data can comprise information associated with a network policy and the devices and/or network protocols of the network policy. By way of further example, the computing system 110 can receive data comprising resource document data associated with a will and the resource data can comprise information associated with the assets and beneficiaries of an estate.

At 704, the method 700 can include determining, based on performance of one or more detection operations on the resource document data, one or more resource document fields and/or one or more resource document field values of the one or more resource documents. For example, the computing system 110 can detect the one or more resource document fields and/or the one or more resource document field values based on the performance of one or more semantic reasoning operations on the one or more resource documents. Further, if the one or more resource documents comprise network policy documents, the computing system 110 can detect the resource document fields associated with device fields and device field values associated with the names of devices of the network. By way of further example, if the one or more resource documents comprise a will, the computing system 110 can detect the resource document fields associated with beneficiary fields and beneficiary field values comprising the names of beneficiaries.

At 706, the method 700 can include generating, based on inputting the resource document data into one or more machine-learning models, resource data associated with the one or more resource documents. The resource data can comprise one or more resource data fields and one or more resource data field values, wherein the one or more resource data fields are based on the one or more resource document fields. Further, the one or more resource data field values can be based on the one or more resource document field values. Further, the one or more machine-learning models can be configured and/or trained to parse the one or more resource documents and determine one or more relationships associated with the one or more entities, the one or more resources, or one or more provisions of the one or more resource documents. For example, the computing system 110 can implement one or more machine-learning models that are configured to receive resource document data comprising a network policy and generate resource data that comprises information associated with relationships between the network configuration, devices on the network, network access policies, and/or users of devices that access the network. The one or more machine-learning models implemented by the computing system 110 can generate output that indicates relationships between devices and users, devices and various sub-networks, and provisions of the network policy including access, authentication, and authorization rules. By way of further example, the computing system 110 can implement one or more machine-learning models that are configured to receive resource document data comprising a will and generate resource data that comprises information associated with relationships between assets of the estate and/or beneficiaries of the estate. The one or more machine-learning models implemented by the computing system 110 can generate output that indicates relationships between different beneficiaries and a testator.

At 708, the method 700 can include determining, based on the resource data, one or more key provisions of the one or more provisions of the one or more resource documents. For example, the computing system 110 can determine one or more key provisions of an access policy that indicate network administrators access rights and password reset policies. By way of further example, the computing system 110 can determine one or more key provisions of a will that indicate the beneficiaries that may receive the most valuable assets of an estate.

At 710, the method 700 can include generating a resource profile based on the resource data. The resource profile can comprise one or more indications associated with the one or more key provisions of the one or more resource documents. For example, the computing system 110 can generate a graphical user interface that comprises a will and key provisions of the will that have been highlighted. By way of further example, the computing system 110 can generate a graphical user interface that comprises a network policy and key provisions of the network policy that have been highlighted.

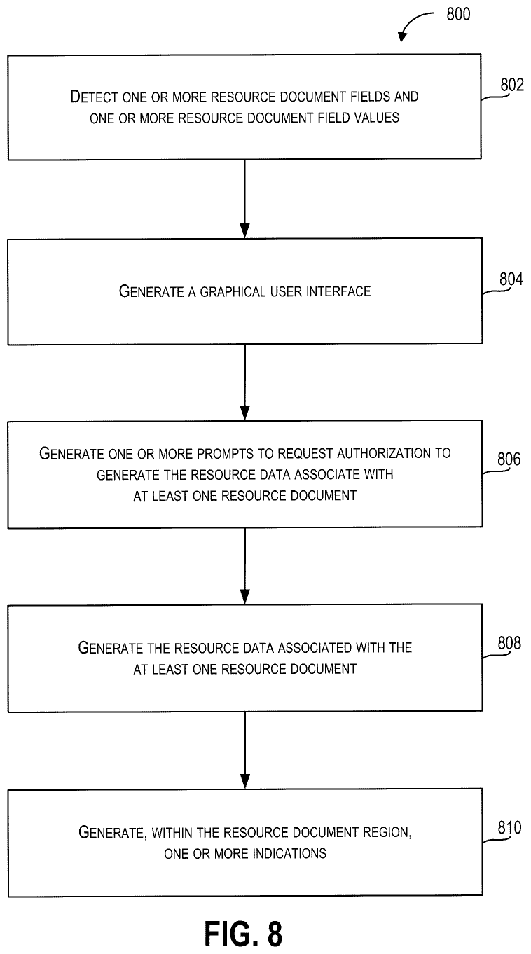

FIG. 8 depicts a flow diagram of generating resource data according to example embodiments of the present disclosure. One or more portions of the method 1000 can be executed and/or implemented on one or more computing devices or computing systems including, for example, the computing system 110, the remote computing system 130, the one or more computing devices 152, and/or the computing device 200. Further, one or more portions of the method 1000 can be executed or implemented as an algorithm on the hardware devices or systems disclosed herein. In some embodiments, one or more portions of the method 800 can be performed as part of the method 700 that is described with respect to FIG. 7. FIG. 10 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 802, the method 800 can include detecting, based on inputting the one or more resource documents into the one or more machine-learning models, the one or more resource document fields, and the one or more resource document field values of the one or more resource documents. The one or more machine-learning models can be configured and/or trained to detect, recognize, and/or parse one or more text segments in the one or more resource documents. For example, the computing system 110 can implement one or more machine-learning models that are configured and/or trained to detect fields and field values of resource documents based on detection of text segments of the resource documents.

At 804, the method 800 can include generating a graphical user interface comprising a resource document region and a resource data region. The resource document region can be configured to display at least one resource document of the one or more resource documents. Further, the resource data region can be configured to display a portion of the resource data associated with the at least one resource document. For example, the computing system 110 can generate a graphical user interface that comprises one side (e.g., a left side) of the interface that displays a resource document comprising a will and another side (e.g., a right side) of the interface that displays resource data based on the resource document and fields of the will (e.g., clauses, names of beneficiaries, and/or assets). By way of further example, the computing system 110 can generate a graphical user interface that comprises one side (e.g., a left side) of the interface that displays a resource document comprising a network policy and another side (e.g., a right side) of the interface that displays resource data based on the resource document and with fields of the network policy (e.g., device names, network names, and/or user names).

At 806, the method 800 can include generating one or more prompts to request authorization to generate the resource data associated with the at least one resource document displayed in the resource document region. For example, the computing system 110 can generate, within the graphical user interface, one or more prompts to request authorization to generate the resource data based on the resource document data. The one or more prompts can comprise interface elements that allow a user to respond to the one or more prompts and generate the resource data based on the resource document data.

At 808, the method 800 can include generating based on a response comprising authorization to generate the resource data, the resource data associated with the at least one resource document displayed in the resource document region. For example, based on a user providing an input (e.g., selecting an interface element using an input device), the computing system 110 can generate the resource data based on the resource document data.

At 810, the method 800 can include generating within the resource document region, one or more indications to emphasize the one or more resource document fields and the one or more resource document field values that are associated with the at least one resource document. For example, the computing system 110 can generate, within the side of the graphical user interface that displays the resource document data associated with a will, a version of the resource document data in which fields of the will (e.g., clauses, names of beneficiaries, and/or assets) are highlighted. By way of further example, the computing system 110 can generate within the side of the graphical user interface that displays the resource document data associated with a network policy, a version of the resource document data in which fields of the network policy (e.g., device names, network names, and/or names of users) are highlighted.

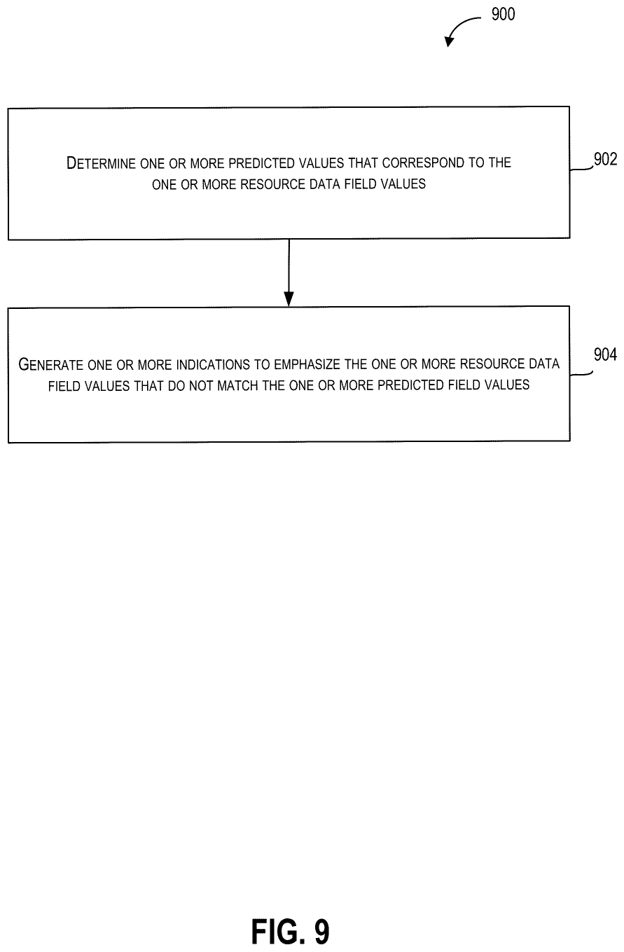

FIG. 9 depicts a flow diagram of generating resource data according to example embodiments of the present disclosure. One or more portions of the method 1000 can be executed and/or implemented on one or more computing devices or computing systems including, for example, the computing system 110, the remote computing system 130, the one or more computing devices 152, and/or the computing device 200. Further, one or more portions of the method 1000 can be executed or implemented as an algorithm on the hardware devices or systems disclosed herein. In some embodiments, one or more portions of the method 900 can be performed as part of the method 700 that is described with respect to FIG. 7. FIG. 10 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 902, the method 900 can include determining, based on inputting the resource data into the one or more machine-learning models, one or more predicted field values that correspond to the one or more resource data field values. For example, the computing system 110 can implement one or more machine-learning models that are configured and/or trained to receive input comprising resource data comprising information associated with asset values of assets of a will and generate output comprising predicted asset values of the assets. For example, the one or more machine-learning models can determine that asset values are off by one or more orders (e.g., the appraised price of a house being $5,000.00) of magnitude and generate predicted asset values that are one or more orders of magnitude greater (e.g., an appraised price of a house being $500,000.00).

At 904, the method 900 can include generating one or more indications to emphasize the one or more resource data field values that do not match the one or more predicted field values. For example, if the resource data field value associated with an asset field of resource data associated with an asset indicated in a will is $5,000.00 and the predicted value of the asset is $500,000.00, the computing system 110 can generate one or more indications comprising underlining and/or highlighting of the resource data field value.

FIG. 10 depicts a flow diagram of generating resource data according to example embodiments of the present disclosure. One or more portions of the method 1000 can be executed and/or implemented on one or more computing devices or computing systems including, for example, the computing system 110, the remote computing system 130, the one or more computing devices 152, and/or the computing device 200. Further, one or more portions of the method 1000 can be executed or implemented as an algorithm on the hardware devices or systems disclosed herein. In some embodiments, one or more portions of the method 1000 can be performed as part of the method 700 that is described with respect to FIG. 7. FIG. 10 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 1002, the method 1000 can include determining, based on inputting the resource data into the one or more machine-learning models, the one or more key provisions (e.g., the one or more key provisions associated with the one or more resource documents). The one or more machine-learning models can be configured and/or trained to determine the one or more key provisions based on performance of one or more semantic reasoning operations on the one or more provisions. For example, the computing system 110 can implement one or more machine-learning models that are configured to receive resource data comprising information associated with a will and generate output comprising key provisions of the will that can comprise provisions associated with major assets and/or major beneficiaries. By way of further example, the computing system 110 can implement one or more machine-learning models that are configured to receive resource data comprising information associated with a network policy and generate output comprising key provisions of the network policy that can comprise provisions associated with administrator passwords and/or access permissions.

At 1004, the method 1000 can include determining the one or more provisions associated with the one or more resource data fields or one or more resource data field values that satisfy one or more provision criteria associated with the one or more entities and/or the one or more resources. Further, the one or more provision criteria can comprise one or more key events associated with the one or more entities or the one or more resources. For example, the computing system 110 can determine the one or more provisions of resource data associated with a will that satisfy one or more provision criteria comprising detection of key events associated with distributing assets to beneficiaries (e.g., a beneficiary graduating high school to qualify for an inheritance). By way of further example, the computing system 110 can determine the one or more provisions of resource data associated with a network policy that satisfy one or more provision criteria comprising detection of key events associated with implementing the network policy (e.g., the timing of software updates for applications associated with the network).

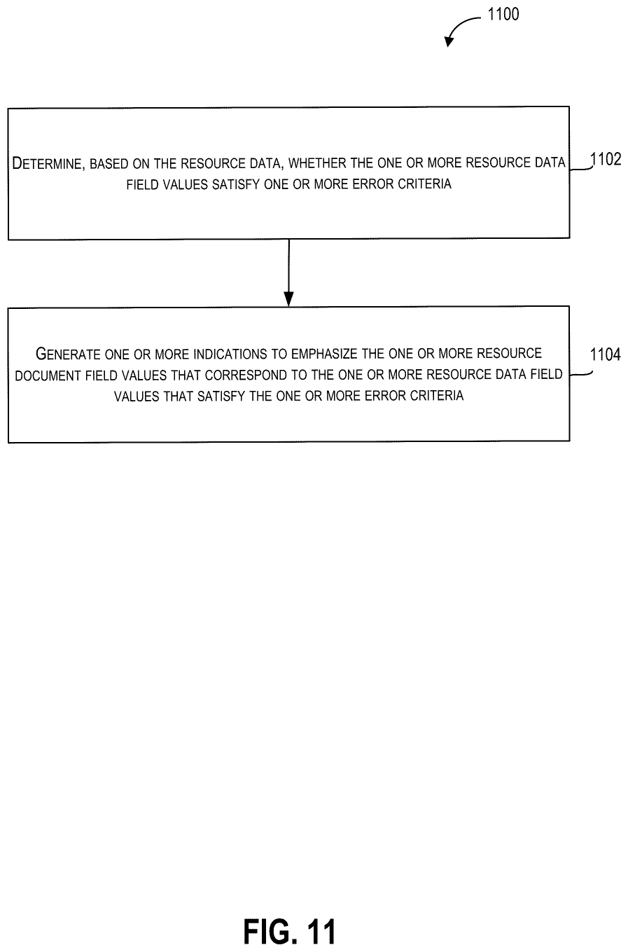

FIG. 11 depicts a flow diagram of generating resource data according to example embodiments of the present disclosure. One or more portions of the method 1000 can be executed and/or implemented on one or more computing devices or computing systems including, for example, the computing system 110, the remote computing system 130, the one or more computing devices 152, and/or the computing device 200. Further, one or more portions of the method 1000 can be executed or implemented as an algorithm on the hardware devices or systems disclosed herein. In some embodiments, one or more portions of the method 1100 can be performed as part of the method 700 that is described with respect to FIG. 7. FIG. 10 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 1102, the method 1100 can include determining, based on the resource data, whether the one or more resource data field values satisfy one or more error criteria associated with one or more errors. For example, the computing system 110 can determine whether the one or more resource data field values associated with asset values of a will satisfy one or more error criteria comprising the asset values of a class of asset exceeding a threshold asset value and/or being less than a threshold asset value. For example, if the resource data field value associated with the value of an asset is empty the one or more error criteria can be satisfied.

At 1104, the method 1100 can include generating one or more indications to emphasize the one or more resource document field values that correspond to the one or more resource data field values that satisfy the one or more error criteria. For example, if the resource data field value associated with the value of an asset indicated in a will is empty, the computing system 110 can generate one or more indications comprising emphasizing the resource data field value associated with the asset value in a bold font.

Numerous details are set forth in the foregoing description. However, it will be apparent to one of ordinary skills in the art having the benefit of this disclosure that the present disclosure may be practiced without these specific details. In some instances, structures and devices are shown in block diagram form, rather than in detail, to avoid obscuring the present disclosure.

Certain examples of the present disclosure can relate to an apparatus for performing the operations described herein. This apparatus may include a computing device that is activated or reconfigured by a computer program comprising electronic instructions stored in the computing device. Such a computer program may be stored in a computer readable storage medium, which can include any type of storage. For example, the storage can include hard disk drives, solid state drives, floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The above description is intended to be illustrative, and not restrictive. The scope of the disclosure can therefore be determined with reference to the claims.

The technology discussed herein makes reference to servers, databases, software applications, and other computer-based systems, as well as actions taken, and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure covers such alterations, variations, and equivalents.

What is claimed is:

1. A computer-implemented method comprising:
receiving, by a computing system comprising one or more processors, resource document data comprising one or more resource documents associated with resource allocation instructions for distribution of one or more resources to one or more entities;
determining, by the computing system, based on performance of one or more detection operations on the resource document data, one or more resource document fields and one or more resource document field values of the one or more resource documents;
generating, by the computing system, based on inputting the resource document data into one or more machine-learning models, resource data associated with the one or more resource documents, wherein the resource data comprises one or more resource data fields and one or more resource data field values, wherein the one or more resource data fields are based on the one or more resource document fields, wherein the one or more resource data field values are based on the one or more resource document field values, and wherein the one or more machine-learning models are configured to parse the one or more resource documents and determine one or more relationships associated with the one or more entities, the one or more resources, or one or more provisions of the one or more resource documents;
determining, by the computing system, based on the resource data, one or more key provisions of the one or more provisions of the one or more resource documents; and
generating, by the computing system, a resource profile based on the resource data, wherein the resource profile comprises one or more indications associated with the one or more key provisions of the one or more resource documents.

2. The computer-implemented method of claim 1, wherein the determining, by the computing system, based on performance of one or more detection operations on the resource document data, one or more resource document fields and one or more resource document field values of the one or more resource documents comprises:
detecting, by the computing system, based on inputting the one or more resource documents into the one or more machine-learning models, the one or more resource document fields and the one or more resource document field values of the one or more resource documents, wherein the one or more machine-learning models are configured to detect, recognize, or parse one or more text segments in the one or more resource documents.

3. The computer-implemented method of claim 1, wherein the generating, by the computing system, based on inputting the resource document data into one or more machine-learning models, resource data associated with the one or more resource documents, wherein the resource data comprises one or more resource data fields and one or more resource data field values, wherein the one or more resource data fields are based on the one or more resource document fields, wherein the one or more resource data field values are based on the one or more resource document field values, and wherein the one or more machine-learning models are configured to parse the one or more resource documents and determine one or more relationships associated with the one or more entities, the one or more resources, or the one or more provisions comprises:
generating, by the computing system, a graphical user interface comprising a resource document region and a resource data region, wherein the resource document region is configured to display at least one resource document of the one or more resource documents, and wherein the resource data region is configured to display a portion of the resource data associated with the at least one resource document;
generating, by the computing system, one or more prompts to request authorization to generate the resource data associated with the at least one resource document displayed in the resource document region; and
generating, by the computing system, based on a response comprising authorization to generate the resource data, the resource data associated with the at least one resource document displayed in the resource document region.

4. The computer-implemented method of claim 3, further comprising:
generating, by the computing system, within the resource document region, one or more indications to emphasize the one or more resource document fields and the one or more resource document field values that are associated with the at least one resource document.

5. The computer-implemented method of claim 1, further comprising:
determining, by the computing system, based on inputting the resource data into the one or more machine-learning models, one or more predicted field values that correspond to the one or more resource data field values; and
generating, by the computing system, one or more indications to emphasize the one or more resource data field values that do not match the one or more predicted field values.

6. The computer-implemented method of claim 5, wherein the one or more machine-learning models are configured to determine one or more confidence values associated with the one or more predicted field values, and wherein the one or more indications comprise the one or more confidence values.

7. The computer-implemented method of claim 5, wherein the one or more indications comprise the one or more predicted field values.

8. The computer-implemented method of claim 5, wherein the one or more resource data field values comprise a signature, and wherein the one or more predicted field values comprise a predicted signature.

9. The computer-implemented method of claim 1, wherein the one or more resource document fields comprise one or more name fields associated with the one or more entities, one or more date fields associated with one or more dates, one or more resource type fields associated with one or more types of one or more resources, or one or more resource value fields associated with one or more resource values of the one or more resources.

10. The computer-implemented method of claim 1, wherein the one or more machine-learning models comprise one or more large language models (LLMs).

11. The computer-implemented method of claim 1, wherein the determining, by the computing system, based on the resource data, one or more key provisions of the one or more provisions of the one or more resource documents comprises:
determining, by the computing system, based on inputting the resource data into the one or more machine-learning models, the one or more key provisions, wherein the one or more machine-learning models are configured to determine the one or more key provisions based on performance of one or more semantic reasoning operations on the one or more provisions.

12. The computer-implemented method of claim 1, wherein the determining, by the computing system, based on the resource data, one or more key provisions of the one or more provisions of the one or more resource documents comprises:
determining, by the computing system, the one or more provisions associated with the one or more resource data fields or one or more resource data field values that satisfy one or more provision criteria associated with the one or more entities or the one or more resources, wherein the one or more provision criteria comprise one or more key events associated with the one or more entities or the one or more resources.

13. The computer-implemented method of claim 1, wherein the one or more resource documents comprise one or more network policies, one or more user guides, one or more access policies, one or more authorization policies, one or more authentication policies, one or more wills, one or more trusts, a power of attorney, one or more titles, one or more deeds, one or more account beneficiary designations, one or more guardianship designations, one or more insurance policies, or one or more healthcare directives.

14. The computer-implemented method of claim 1, further comprising:
determining, by the computing system, based on the resource data, whether the one or more resource data field values satisfy one or more error criteria associated with one or more errors; and
generating, by the computing system, one or more indications to emphasize the one or more resource document field values that correspond to the one or more resource data field values that satisfy the one or more error criteria.

15. The computer-implemented method of claim 14, wherein satisfying the one or more error criteria comprises the one or more resource data field values being associated with one or more misspellings, the one or more resource data field values comprising one or more resource values that are not within a resource value range, the one or more resource data field values comprising an invalid type of field value, or the one or more resource data field values comprising a null value.

16. The computer-implemented method of claim 1, wherein the one or more relationships comprise one or more fiduciary relationships between the one or more entities, one or more property rights of the one or more entities over the one or more resources, one or more relationships between terms or conditions of the one or more provisions, one or more relationships between the one or more provisions and the one or more entities, or one or more relationships between the one or more provisions and the one or more resources.

17. A computing system, comprising:
one or more processors;
one or more non-transitory computer-readable media storing instructions that, when executed by the one or more processors, cause the computing system to perform operations, the operations comprising:
receiving resource document data comprising one or more resource documents associated with resource allocation instructions for distribution of one or more resources to one or more entities;
determining, based on performance of one or more detection operations on the resource document data, one or more resource document fields and one or more resource document field values of the one or more resource documents;
generating, based on inputting the resource document data into one or more machine-learning models, resource data associated with the one or more resource documents, wherein the resource data comprises one or more resource data fields and one or more resource data field values, wherein the one or more resource data fields are based on the one or more resource document fields, wherein the one or more resource data field values are based on the one or more resource document field values, and wherein the one or more machine-learning models are configured to parse the one or more resource documents and determine one or more relationships associated with the one or more entities, the one or more resources, or one or more provisions of the one or more resource documents;
determining, based on the resource data, one or more key provisions of the one or more provisions of the one or more resource documents; and
generating a resource profile based on the resource data, wherein the resource profile comprises one or more indications associated with the one or more key provisions of the one or more resource documents.

18. The computing system of claim 17, wherein the operations further comprise:
determining, based on inputting the resource data into the one or more machine-learning models, one or more predicted field values that correspond to the one or more resource data field values; and
generating one or more indications to emphasize the one or more resource data field values that do not match the one or more predicted field values.

19. One or more non-transitory computer-readable media that collectively store instructions that, when executed by one or more computing devices, cause the one or more computing devices to perform operations, the operations comprising:
receiving resource document data comprising one or more resource documents associated with resource allocation instructions for distribution of one or more resources to one or more entities;
determining, based on performance of one or more detection operations on the resource document data, one or more resource document fields and one or more resource document field values of the one or more resource documents;
generating, based on inputting the resource document data into one or more machine-learning models, resource data associated with the one or more resource documents, wherein the resource data comprises one or more resource data fields and one or more resource data field values, wherein the one or more resource data fields are based on the one or more resource document fields, wherein the one or more resource data field values are based on the one or more resource document field values, and wherein the one or more machine-learning models are configured to parse the one or more resource documents and determine one or more relationships associated with the one or more entities, the one or more resources, or one or more provisions of the one or more resource documents;
determining, based on the resource data, one or more key provisions of the one or more provisions of the one or more resource documents; and
generating a resource profile based on the resource data, wherein the resource profile comprises one or more indications associated with the one or more key provisions of the one or more resource documents.

20. The one or more non-transitory computer-readable media of claim 19, wherein the operations further comprise:
determining, based on inputting the resource data into the one or more machine-learning models, one or more predicted field values that correspond to the one or more resource data field values; and
generating one or more indications to emphasize the one or more resource data field values that do not match the one or more predicted field values.
